(19) United States
(12) Patent Application Publication
(10) Pub. No.: US 2024/0281649 A1
(43) Pub. Date: Aug. 22, 2024

(54) DISTILLATION OF DEEP ENSEMBLES

(71) Applicant: GE Precision Healthcare LLC, Wauwatosa, WI (US)

(72) Inventors: Hariharan Ravishankar, Bengaluru (IN); Prasad Sudhakara Murthy, Bengaluru (IN); Rohan Patil, Bengaluru (IN)

(21) Appl. No.: 18/170,888

(22) Filed: Feb. 17, 2023

(51) Int. Cl. G06N 3/08; G06N 5/04

(52) U.S. Cl. CPC G06N 3/08; G06N 5/04

(57) ABSTRACT

Systems/techniques that facilitate improved distillation of deep ensembles are provided. In various embodiments, a system can access a deep learning ensemble configured to perform an inferencing task. In various aspects, the system can iteratively distill the deep learning ensemble into a smaller deep learning ensemble configured to perform the inferencing task, wherein a current distillation iteration can involve training a new neural network of the smaller deep learning ensemble via a loss function that is based on one or more neural networks of the smaller deep learning ensemble which were trained during one or more previous distillation iterations.

### TECHNICAL FIELD

The subject disclosure relates generally to deep ensembles, and more specifically to improved distillation of deep ensembles.

### BACKGROUND

A deep ensemble can be trained to perform an inferencing task. Although the deep ensemble can achieve high inferencing accuracy and can be amenable to uncertainty quantification, the deep ensemble can consume excessive computational resources, which can restrict adoption or deployment of the deep ensemble. To reduce such excessive consumption of computational resources, knowledge distillation can be implemented.

Some existing techniques for facilitating knowledge distillation involve distilling the deep ensemble into a single neural network. Such single neural network can achieve comparable inferencing accuracy as the deep ensemble while consuming significantly fewer computational resources. Unfortunately, however, the single neural network can be unamenable to uncertainty quantification, unlike the deep ensemble.

Other existing techniques for facilitating knowledge distillation involve distilling the deep ensemble into a condensed deep ensemble having a pre-set, pre-defined, or fixed size that is smaller than that of the deep ensemble. The condensed deep ensemble can be amenable to uncertainty quantification. However, the condensed deep ensemble can pose a trade-off between inferencing accuracy and computational footprint, which trade-off can be a function of the pre-set, pre-defined, or fixed size of the condensed deep ensemble. Indeed, in some instances, the fixed size of the condensed deep ensemble can be too big, in which case the condensed deep ensemble can achieve comparable inferencing accuracy as the deep ensemble but can be considered as still consuming too many computational resources. In other instances, the fixed size of the condensed deep ensemble can be too small, in which case the condensed deep ensemble can consume significantly fewer computational resources than the deep ensemble but cannot achieve comparable inferencing accuracy.

Accordingly, systems or techniques that can facilitate improved distillation of deep ensembles can be considered as desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate improved distillation of deep ensembles are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a deep learning ensemble configured to perform an inferencing task. In various aspects, the computer-executable components can comprise a distillation component that can iteratively distill the deep learning ensemble into a smaller deep learning ensemble configured to perform the inferencing task, wherein a current distillation iteration can involve training a new neural network of the smaller deep learning ensemble via a loss function that is based on one or more neural networks of the smaller deep learning ensemble which were trained during one or more previous distillation iterations.

According to one or more embodiments, a computer-implemented method is provided. In various embodiments, the computer-implemented method can comprise accessing, by a device operatively coupled to a processor, a deep learning ensemble configured to perform an inferencing task. In various aspects, the computer-implemented method can comprise iteratively distilling, by the device, the deep learning ensemble into a smaller deep learning ensemble configured to perform the inferencing task, wherein a current distillation iteration can involve training a new neural network of the smaller deep learning ensemble via a loss function that is based on one or more neural networks of the smaller deep learning ensemble which were trained during one or more previous distillation iterations.

According to one or more embodiments, a computer program product for facilitating improved distillation of deep ensembles is provided. In various embodiments, the computer program product can comprise a non-transitory computer-readable memory having program instructions embodied therewith. In various aspects, the program instructions can be executable by a processor to cause the processor to access an ensemble of teacher networks and a training dataset on which the ensemble of teacher networks was trained. In various instances, the program instructions can be further executable to cause the processor to iteratively train a condensed ensemble of student networks based on the ensemble of teacher networks and based on the training dataset, wherein each new student network of the condensed ensemble can be trained via a loss that is based on all previously-trained student networks in the condensed ensemble.

### DESCRIPTION OF THE DRAWINGS

FIG. 1 illustrates a block diagram of an example, non-limiting system that facilitates improved distillation of deep ensembles in accordance with one or more embodiments described herein.

FIG. 2 illustrates an example, non-limiting block diagram of a deep ensemble and of a training dataset in accordance with one or more embodiments described herein.

FIG. 3 illustrates a block diagram of an example, non-limiting system including a condensed deep ensemble, a retrospective loss function, and an ensemble saturation threshold that facilitates improved distillation of deep ensembles in accordance with one or more embodiments described herein.

FIG. 4 illustrates an example, non-limiting block diagram of a condensed deep ensemble and of a retrospective loss function in accordance with one or more embodiments described herein.

FIG. 5 illustrates an example, non-limiting block diagram showing how a ground-truth error term of a retrospective loss function can be obtained in accordance with one or more embodiments described herein.

FIG. 6 illustrates an example, non-limiting block diagram showing how a distillation error term of a retrospective loss function can be obtained in accordance with one or more embodiments described herein.

FIG. 7 illustrates an example, non-limiting block diagram showing how a similarity error term of a retrospective loss function can be obtained in accordance with one or more embodiments described herein.

FIG. 8 illustrates an example, non-limiting block diagram showing how a similarity error term of a retrospective loss function can be obtained in a parameter-space of student neural networks in accordance with one or more embodiments described herein.

FIGS. 9-10 illustrate example, non-limiting block diagrams showing how a similarity error term of a retrospective loss function can be obtained in a feature-space of student neural networks in accordance with one or more embodiments described herein.

FIG. 11 illustrates an example, non-limiting block diagram showing how an ensemble saturation threshold can be used to determine whether a condensed ensemble of student networks is complete in accordance with one or more embodiments described herein.

FIG. 12 illustrates a flow diagram of an example, non-limiting computer-implemented method that facilitates improved distillation of deep ensembles in accordance with one or more embodiments described herein.

FIG. 13 illustrates a flow diagram of an example, non-limiting computer-implemented method that facilitates improved distillation of deep ensembles in accordance with one or more embodiments described herein.

FIG. 14 illustrates a block diagram of an example, non-limiting operating environment in which one or more embodiments described herein can be facilitated.

FIG. 15 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A deep ensemble can be trained to perform an inferencing task (e.g., classification, segmentation, regression) on a data candidate (e.g., one or more scalars, vectors, matrices, tensors, or character strings). In particular, the deep ensemble can be a plurality of deep learning neural networks, each of which can be independently trained (e.g., in supervised fashion, in unsupervised fashion, in reinforcement learning fashion) from a unique random initialization of trainable internal parameters (e.g., weight matrices, biases, convolutional kernels) to perform the inferencing task. So, when it is desired to perform the inferencing task on a given data candidate, each deep learning neural network in the deep ensemble can be executed (e.g., in parallel) on the given data candidate, thereby yielding a plurality of individual inferencing task results (e.g., a plurality of individual classification labels, a plurality of individual segmentation masks, a plurality of individual regression outputs), and such plurality of individual inferencing task results can be combined (e.g., via averaging) to form an aggregated inferencing task result (e.g., an aggregated classification label, an aggregated segmentation mask, an aggregated regression output). Such aggregated inferencing task result can be considered as the prediction that is outputted by the deep ensemble in response to receiving the given data candidate as input.

Through training, the deep ensemble can achieve high prediction accuracy, even in operational contexts that involve high class-imbalance or data diversity. Indeed, different deep learning neural networks in the deep ensemble can be considered as having learned how to handle (e.g., how to accurately analyze) data candidates from different feature distributions (e.g., data candidates representing different cohorts, different demographics, different characteristics, or different attributes). Accordingly, when such different deep learning neural networks are ensembled together, they can collectively be considered as having learned how to handle the entire domain of feature distributions encountered during training. In other words, even if one deep learning neural network in the deep ensemble incorrectly analyzes the given data candidate, it can nevertheless be possible that more than one other deep learning neural network in the deep ensemble correctly analyze the given data candidate, such that the aggregated inferencing task result can be considered as being more accurate than inaccurate. In still other words, each deep learning neural network in the deep ensemble can be considered as casting a vote for how it believes the given data candidate should be analyzed, and the deep ensemble can achieve high collective inferencing accuracy because less-accurate votes can be outweighed or outnumbered by more-accurate votes.

Although the deep ensemble can achieve high inferencing accuracy, the deep ensemble can consume excessive computational resources (e.g., computer memory, computer processing capacity, inferencing time). In particular, one deep learning neural network can contain hundreds, thousands, or even millions of internal parameters. Electronic storage of such voluminous internal parameters can require commensurately voluminous computer memory (e.g., hard disk drive space). Likewise, electronic execution of such voluminous internal parameters can require commensurately voluminous processing capacity (e.g., random access memory space) and commensurately long inferencing times (e.g., from milliseconds to multiple seconds). Such utilization of computer memory, processing capacity, and inferencing time can be significantly exacerbated when multiple of such deep learning neural networks are ensembled together. In other words, one deep learning neural network can be considered as already having a large computational footprint, and thus the deep ensemble, which contains multiple deep learning neural networks, can be considered as having an even larger computational footprint (e.g., the footprint of the deep ensemble can be considered as the sum of the footprints of its constituent deep learning neural networks). Such excessive consumption of computational resources can impede or otherwise restrict adoption or deployment of the deep ensemble. For instance, clients that rely upon resource-constrained machinery (e.g., medical imaging scanners) might opt to not deploy or utilize the deep ensemble due to its heavy computational cost.

To reduce such excessive consumption of computational resources, knowledge distillation can be implemented.

Some existing techniques for facilitating knowledge distillation involve distilling the deep ensemble into a single deep learning neural network. In particular, the single deep learning neural network can consume significantly fewer computational resources than the deep ensemble, and such existing techniques can involve training that single deep learning neural network to emulate the inferencing behavior of the entire deep ensemble, such that the single deep learning neural network can achieve comparable inferencing accuracy as the deep ensemble. Unfortunately, however, the single deep learning neural network can be unamenable to uncertainty quantification, unlike the deep ensemble. Indeed, an advantage of utilizing the deep ensemble for performing the inferencing task is that uncertainty metrics (e.g., mean, standard deviation, variance, expected calibration error) can be computed across the individual inferencing task results that are outputted by the constituent deep learning neural networks that make up the deep ensemble. If the deep ensemble is distilled into the single deep learning neural network, such uncertainty metrics can no longer be obtained.

Other existing techniques for facilitating knowledge distillation involve distilling the deep ensemble into a condensed deep ensemble that has a pre-set or pre-defined size which is smaller than the size of the deep ensemble. In other words, the condensed deep ensemble can be created so that its number of constituent deep learning neural networks is fixed to be less than the number of constituent deep learning neural networks that make up the deep ensemble, and each constituent deep learning neural network of the condensed deep ensemble can have a comparable or smaller individual footprint as each constituent deep learning neural network of the deep ensemble. Such condensed deep ensemble can be considered as being amenable to uncertainty quantification. However, such condensed deep ensemble can be considered as posing a difficult-to-navigate trade-off between inferencing accuracy and computational footprint, which trade-off can depend upon the fixed size of the condensed deep ensemble. For example, in some cases, the fixed size of the condensed deep ensemble can be too small, such that the condensed deep ensemble can consume significantly fewer computational resources than the deep ensemble, but such that the condensed deep ensemble cannot achieve comparable inferencing accuracy as the deep ensemble. Conversely, in other cases, the fixed size of the condensed deep ensemble can be too large, such that the condensed deep ensemble can achieve comparable inferencing accuracy as the deep ensemble, but such that the condensed deep ensemble can nevertheless be considered as consuming more computational resources than necessary. In other words, when these existing techniques are implemented, it can be unknown what minimum or approximately minimum size would allow the condensed deep ensemble to achieve comparable inferencing accuracy as the deep ensemble.

Accordingly, systems or techniques that can facilitate improved distillation of deep ensembles can be considered as desirable.

Various embodiments described herein can address one or more of these technical problems. One or more embodiments described herein can include systems, computer-implemented methods, apparatus, or computer program products that can facilitate improved distillation of deep ensembles. In other words, the inventors of various embodiments described herein devised various knowledge distillation techniques which can distill a deep ensemble into a condensed deep ensemble, where such techniques can cause the condensed deep ensemble to achieve comparable (or better) inferencing accuracy as the deep ensemble while also having a minimized or approximately minimized size (and thus a minimized or approximately minimized computational footprint).

In particular, the present inventors recognized that existing techniques for distilling a deep ensemble into a condensed deep ensemble fix the number of constituent deep learning neural networks of the condensed deep ensemble at a desired value and then independently train those constituent deep learning neural networks. The present inventors realized that such independent training can result in inter-neural-network redundancy across the condensed deep ensemble, which can cause the condensed deep ensemble to have a larger computational footprint than necessary. In other words, the present inventors recognized that, by training the constituent deep learning neural networks of the condensed deep ensemble independently of each other, it is likely that at least some of the trainable internal parameters (e.g., some of the weight matrices, biases, or convolutional kernels) of those constituent deep learning neural networks coincidentally become similar to each other. In still other words, the present inventors realized that such independent training can cause various of the constituent deep learning neural networks to superfluously learn how to analyze the same features as each other, which can be considered as wasteful. Accordingly, the present inventors realized that reducing or eliminating such inter-neural-network redundancy can help to minimize or approximately minimize the computational footprint of the condensed deep ensemble without sacrificing inferencing accuracy.

Thus, the present inventors devised an iterative knowledge distillation technique for reducing or eliminating such inter-neural-network redundancy. In particular, the condensed deep ensemble can begin as an empty set. At each knowledge distillation iteration of such technique, a new deep learning neural network can be inserted into the condensed deep ensemble, the trainable internal parameters of such new deep learning neural network can be randomly initialized, and such new deep learning neural network can be trained using a retrospective loss. In various aspects, the retrospective loss can be based on other deep learning neural networks that had been previously inserted into the condensed deep ensemble during prior knowledge distillation iterations, hence the term “retrospective”. In various instances, the retrospective loss can be considered as indicating or representing how similar the new deep learning neural network is to those previously-inserted deep learning neural networks. In some cases, the retrospective loss can quantify parameter-space similarities between the new deep learning neural network and those previously-inserted deep learning neural networks. In other cases, the retrospective loss can quantify feature-space similarities between the new deep learning neural network and those previously-inserted deep learning neural networks. In any case, training of the new deep learning neural network can cause the retrospective loss (e.g., such parameter-space or feature-space similarities) to become minimized, which can correspondingly cause the new deep learning neural network to become different from or dissimilar to those previously-inserted deep learning neural networks. That is, training the new deep learning neural network using the retrospective loss can cause the new deep learning neural network to become non-redundant with (e.g., to not superfluously learn to detect the same features as) those previously-inserted deep learning neural networks. In other words, the new deep learning neural network can be considered as not being trained independently of those previously-inserted deep learning neural networks. After the new deep learning neural network has been trained using the retrospective loss, a performance metric (e.g., test accuracy percentage) of the condensed deep ensemble with respect to a validation dataset can be computed. In various instances, such performance metric can be compared to a previous performance metric of the condensed deep ensemble that was computed during a previous iteration (e.g., the accuracy of the condensed deep ensemble can be evaluated with the new deep learning neural network and without the new deep learning neural network). If such performance metric and such previous performance metric differ by at least a threshold margin, then a next or succeeding knowledge distillation iteration can be commenced. In contrast, if such performance metric and such previous performance metric do not differ by at least the threshold margin, then the condensed deep ensemble can be considered as being complete.

As described herein, iteratively constructing the condensed deep ensemble using the retrospective loss can cause the condensed deep ensemble to achieve comparable (or even better) inferencing accuracy as the original deep ensemble while also having a minimized or approximately minimized computational footprint (e.g., while also having as few constituent deep learning neural networks as feasible). Contrast this with existing techniques, which instead fix the size of the condensed deep ensemble a priori and train each constituent deep learning neural network of the condensed deep ensemble independently of (e.g., without regard to) each other.

Various embodiments described herein can be considered as a computerized tool (e.g., any suitable combination of computer-executable hardware or computer-executable software) that can facilitate improved distillation of deep ensembles. In various aspects, such computerized tool can comprise an access component, a distillation component, or an execution component.

In various embodiments, there can be a deep ensemble. In various aspects, the deep ensemble can be configured to perform an inferencing task on data candidates. In various instances, a data candidate can be any suitable electronic data exhibiting any suitable format, size, or dimensionality. As some non-limiting examples, a data candidate can be an image, a video file, an audio file, or a waveform-spectra file. In various cases, the inferencing task can be any suitable computational, predictive task that can be performed on or with respect to a data candidate. As some non-limiting examples, the inferencing task can be classification, segmentation, or regression (e.g., denoising, resolution enhancement).

In various aspects, the deep ensemble can comprise a plurality of teacher networks. In various instances, a teacher network can be any suitable deep learning neural network which can exhibit any suitable internal architecture. For example, a teacher network can include any suitable numbers of any suitable types of layers (e.g., input layer, one or more hidden layers, output layer, any of which can be convolutional layers, dense layers, non-linearity layers, pooling layers, batch normalization layers, or padding layers). As another example, a teacher network can include any suitable numbers of neurons in various layers (e.g., different layers can have the same or different numbers of neurons as each other). As yet another example, a teacher network can include any suitable activation functions (e.g., softmax, sigmoid, hyperbolic tangent, rectified linear unit) in various neurons (e.g., different neurons can have the same or different activation functions as each other). As still another example, a teacher network can include any suitable interneuron connections or interlayer connections (e.g., forward connections, skip connections, recurrent connections). In some cases, different teacher networks of the deep ensemble can have the same or different internal architectures as each other.

In any case, each teacher network of the deep ensemble can be configured to perform the inferencing task on an inputted data candidate. In other words, each teacher network can be configured to receive as input a data candidate and to produce as output an inferencing task result (e.g., a classification label, a segmentation mask, a regression output) corresponding to that data candidate. When given a particular data candidate on which it is desired to perform the inferencing task, each teacher network of the deep ensemble can be executed (e.g., in parallel) on the particular data candidate, thereby yielding a plurality of inferencing task results, and such plurality of inferencing task results can be averaged or otherwise combined to form an aggregated inferencing task result. In various instances, such aggregated inferencing task result can be considered as being the output that the deep ensemble produces in response to receiving the particular data candidate as input.

In various aspects, there can be a training dataset. In various instances, the training dataset can comprise a set of training data candidates and a set of ground-truth annotations that respectively correspond to the set of training data candidates. In various cases, a training data candidate can be any suitable data candidate that the deep ensemble (e.g., that any teacher network of the deep ensemble) encountered during training. In various aspects, each ground-truth annotation can be considered as being any suitable electronic data that indicates or otherwise represents a correct or accurate inferencing task result (e.g., correct or accurate classification label, correct or accurate segmentation mask, correct or accurate regression output) that is known or deemed to correspond to a respective training data candidate.

In various instances, it can be desired to distill the deep ensemble into a condensed deep ensemble that has a minimized or approximately minimized computational footprint and that nevertheless has comparable (or better) inferencing accuracy. As described herein, the computerized tool can facilitate such distillation.

In various embodiments, the access component of the computerized tool can electronically receive or otherwise electronically access the deep ensemble or the training dataset. In some aspects, the access component can electronically retrieve the deep ensemble or the training dataset from any suitable centralized or decentralized data structures (e.g., graph data structures, relational data structures, hybrid data structures), whether remote from or local to the access component. In any case, the access component can electronically obtain or access the deep ensemble or the training dataset, such that other components of the computerized tool can electronically interact with (e.g., read, write, edit, copy, manipulate) the deep ensemble or with the training dataset.

In various embodiments, the distillation component of the computerized tool can electronically and iteratively distill the deep ensemble into a condensed deep ensemble. In various aspects, the distillation component can facilitate such iterative distillation via a retrospective loss function and via an ensemble saturation threshold.

In various instances, the condensed deep ensemble can be configured to perform the inferencing task on data candidates. In various cases, the condensed deep ensemble can comprise a plurality of student networks, where a student network can be any suitable deep learning neural network having any suitable internal architecture. For example, a student network can include any suitable numbers of any suitable types of layers (e.g., input layer, one or more hidden layers, output layer, any of which can be convolutional layers, dense layers, non-linearity layers, pooling layers, batch normalization layers, or padding layers). As another example, a student network can include any suitable numbers of neurons in various layers (e.g., different layers can have the same or different numbers of neurons as each other). As yet another example, a student network can include any suitable activation functions (e.g., softmax, sigmoid, hyperbolic tangent, rectified linear unit) in various neurons (e.g., different neurons can have the same or different activation functions as each other). As still another example, a student network can include any suitable interneuron connections or interlayer connections (e.g., forward connections, skip connections, recurrent connections). In some cases, different student networks of the condensed deep ensemble can have the same internal architectures as each other.

In various aspects, each student network can be considered as being smaller (e.g., as having a smaller computational footprint) than each teacher network. As a non-limiting example, each student network can comprise fewer neural network layers than each teacher network or fewer trainable internal parameters than each teacher network. Moreover, in various instances, the cardinality of the condensed deep ensemble can be less than the cardinality of the deep ensemble. In other words, there can be fewer student networks in the condensed deep ensemble than there are teacher networks in the deep ensemble. Accordingly, the condensed deep ensemble can be considered as exhibiting a smaller computational footprint than the deep ensemble (e.g., can consume less computer memory during electronic storage, can consume less computer processing capacity during electronic execution, can consume less computation time during electronic execution).

In various aspects, the distillation component can electronically generate the condensed deep ensemble by performing any suitable number of knowledge distillation iterations, where each knowledge distillation iteration can utilize the retrospective loss function and the ensemble saturation threshold. More specifically, the retrospective loss function can be a training error that can drive backpropagation (e.g., stochastic gradient descent), and the ensemble saturation threshold can be any suitable positive, real-valued scalar. In various instances, the condensed deep ensemble can begin as an empty set, and, during each knowledge distillation iteration, the distillation component can: insert a new student network into the condensed deep ensemble; randomly initialize the trainable internal parameters of the new student network; train the new student network on the training dataset so as to minimize, via backpropagation, the retrospective loss function; and proceed to a next knowledge distillation iteration unless a percentage change in a performance metric of the condensed deep ensemble is below the ensemble saturation threshold.

To help clarify, consider the behavior of the distillation component during a current knowledge distillation iteration. During the current knowledge distillation iteration, the distillation component can electronically add to the condensed deep ensemble a new student network, where such new student network can have randomly initialized trainable internal parameters (e.g., randomly initialized weight matrices, randomly initialized biases, randomly initialized convolutional kernels).

During the current knowledge distillation iteration, the distillation component can perform any suitable number of training iterations on the new student network based on the training dataset.

In particular, during any given training iteration within the current knowledge distillation iteration, the distillation component can select from the training dataset any suitable training data candidate and any suitable ground-truth annotation that corresponds to the selected training data candidate. Furthermore, during the given training iteration of the current knowledge distillation iteration, the distillation component can execute the new student network on the selected training data candidate, which can cause the new student network to produce an output. For example, the distillation component can feed the selected training data candidate to an input layer of the new student network, the selected training data candidate can complete a forward pass through one or more hidden layers of the new student network, and an output layer of the new student network can compute the output based on activations from the one or more hidden layers. Note that, in various cases, the format, size, or dimensionality of the output can be controlled or otherwise determined by the number or arrangement of neurons (or by the number or arrangement of other internal parameters, such as convolutional kernels) that are in the output layer of the new student network. That is, the output can be forced to have a desired format, size, or dimensionality by adding or removing neurons or other internal parameters to or from the output layer of the new student network.

In any case, the output can be considered as a predicted inferencing task result (e.g., predicted or inferred classification label, predicted or inferred segmentation mask, predicted or inferred regression output) that the new student network believes should correspond to the selected training data candidate. In contrast, the selected ground-truth annotation can be considered as the correct or accurate inferencing task result (e.g., correct or accurate classification label, correct or accurate segmentation mask, correct or accurate regression output) that is known or deemed to correspond to the selected training data candidate. Note that, if the new student network has so far undergone no or little training, then the output can be highly incorrect (e.g., can be highly different from the selected ground-truth annotation).

In various aspects, the distillation component can, during the given training iteration of the current knowledge distillation iteration, compute a first term of the retrospective loss function, based on the output produced by the new student network and based on the selected ground-truth annotation. As some non-limiting examples, the first term can be a mean absolute error (MAE), a mean squared error (MSE), a cross-entropy error, or a Kullback-Leibler divergence loss between the output and the selected ground-truth annotation. In any case, the first term can be considered as quantifying how well or how poorly the new student network has predicted the selected ground-truth annotation.

Moreover, during the given training iteration of the current knowledge distillation iteration, the distillation component can also execute the deep ensemble on the selected training data candidate, which can cause the deep ensemble to produce an aggregated output. For example, the distillation component can feed the selected training data candidate to each teacher network within the deep ensemble, the selected training data candidate can complete a forward pass through each teacher network, each teacher network can produce an individual inferencing task result (e.g., an individual classification label, an individual segmentation mask, an individual regression output) based on the selected training data candidate, and those individual inferencing task results can be combined (e.g., via weighted or non-weighted averaging) to form the aggregated output (e.g., an aggregated classification label, an aggregated segmentation mask, an aggregated regression output). Accordingly, the aggregated output can be considered as a predicted inferencing task result that the deep ensemble collectively believes should correspond to the selected training data candidate. In contrast, and as mentioned above, the output produced by the new student network can be considered as a predicted inferencing task result that the new student network believes should correspond to the selected training data candidate.

In various aspects, the distillation component can, during the given training iteration of the current knowledge distillation iteration, compute a second term of the retrospective loss function, based on the output produced by the new student network and based on the aggregated output produced by the deep ensemble. As some non-limiting examples, the second term can be a mean absolute error (MAE), a mean squared error (MSE), a cross-entropy error, or a Kullback-Leibler divergence loss between the output and the aggregated output. In any case, the second term can be considered as quantifying how well or how poorly the new student network has emulated the inferencing behavior of the deep ensemble.

Furthermore, during the given training iteration of the current knowledge distillation iteration, the distillation component can compute a third term of the retrospective loss function, where the third term can be based on old student networks that had been added to the condensed deep ensemble during previous knowledge distillation iterations. In various aspects, the third term can be considered as quantifying similarities between the new student network and every old student network that had previously been inserted into the condensed deep ensemble. For example, a parameter-space cosine similarity can be computed between the trainable internal parameters of the new student network and the trainable internal parameters of each old student network that had been previously added to the condensed deep ensemble, and the third term can be any suitable combination (e.g., linear or non-linear) of such cosine similarities. As another example, a reciprocal of feature-space Euclidean distance can be computed between the hidden activations of the new student network and hidden activations of each old student network that had been previously added to the condensed deep ensemble, and the third term can be any suitable combination (e.g., linear or non-linear) of such reciprocals. In any case, the third term can be considered as quantifying how similar the inferencing behavior of the new student network is to inferencing behaviors of the old student networks.

Note that the retrospective loss function can be any suitable additive, multiplicative, or exponential combination of the first, second, and third terms. Furthermore, note that, if the current knowledge distillation iteration is the very first knowledge distillation iteration (e.g., if there are no old student networks that had been previously inserted into the condensed deep ensemble), the third term can be omitted from the retrospective loss function.

In any case, during the given training iteration of the current knowledge distillation iteration, the distillation component can incrementally update the trainable internal parameters of the new student network, via backpropagation (e.g., stochastic gradient descent) driven by the retrospective loss function. A next or succeeding training iteration of the current knowledge distillation iteration can then be initiated. Although the above paragraphs describe such training iterations as implementing a training batch size of one, this is a mere non-limiting example for ease of explanation. In various instances, the distillation component can implement any suitable training batch sizes when training the new student network during the current knowledge distillation iteration.

In various aspects, any suitable number of training iterations can be performed within the current knowledge distillation iteration. For example, such training iterations can be repeatedly performed until any suitable training termination criterion is achieved with respect to the new student network. Such repeated training iterations within the current knowledge distillation iteration can cause the trainable internal parameters of the new student network to become iteratively optimized for performing the inferencing task on inputted data candidates. In particular, the first term of the retrospective loss function can cause the new student network to learn how to accurately or correctly perform the inferencing task. Moreover, the second term of the retrospective loss function can cause the new student network to learn how to emulate or copy the inferencing behavior of the deep ensemble. Furthermore, the third term of the retrospective loss function can cause the trainable internal parameters of the new student network to become dissimilar to or non-redundant with those of the old student networks that had been previously added to the condensed deep ensemble. Indeed, because the third term can compare the new student network will those old student networks, the third term can be considered as backward-looking, hence the term “retrospective”. In still other words, the third term can ensure that the new student network is not being trained independently of the old student networks.

In any case, once the new student network has been trained during the current knowledge distillation iteration, the distillation component can evaluate a performance metric (e.g., accuracy) of the current version of the condensed deep ensemble (e.g., using any suitable validation dataset). If a percentage change in such performance metric is greater than (or equal to) the ensemble saturation threshold, then the distillation component can conclude that the condensed deep ensemble is not yet saturated. In other words, the distillation component can conclude that the addition of the new student network improved the performance of the condensed deep ensemble by a sufficiently significant margin, such that the condensed deep ensemble might plausibly benefit from addition of yet another student network. Accordingly, the distillation component can proceed to a next knowledge distillation iteration. On the other hand, if the percentage change in such performance metric is lesser than (or equal to) the ensemble saturation threshold, then the distillation component can conclude that the condensed deep ensemble is now saturated. In other words, the distillation component can conclude that the addition of the new student network improved the performance of the condensed deep ensemble by an insufficiently significant margin, such that the condensed deep ensemble will not plausibly benefit from addition of yet another student network. Accordingly, the distillation component can cease performing knowledge distillation iterations, and the condensed deep ensemble can be considered as now being complete.

In various embodiments, based on the distillation component concluding that the condensed deep ensemble is complete, the execution component of the computerized tool can electronically deploy the condensed deep ensemble in any suitable operational context (e.g., in a clinical/medical setting, in non-clinical/non-medical settings, in laboratory/research settings). For example, when given any data candidate for which a ground-truth annotation is not available, the execution component can electronically execute the condensed deep ensemble on that data candidate. This can cause each student network in the condensed ensemble to produce an individual inferencing task result for that data candidate, and such individual inferencing task results can be combined (e.g., averaged) to form an aggregated inferencing task result for that data candidate.

In any case, and as the present inventors experimentally verified, generating the condensed deep ensemble via the retrospective loss function and via the ensemble saturation threshold as described herein can cause the condensed deep ensemble to achieve comparable (or even better) inferencing accuracy as the deep ensemble while also having a minimized or approximately minimized computational footprint. In particular, the ensemble saturation threshold can be considered as demarcating when the condensed deep ensemble has achieved sufficient inferencing accuracy; and the retrospective loss function (e.g., the third term, specifically) can be considered as causing the student networks of the condensed deep ensemble to be non-redundant with each other. Such non-redundancy can allow the condensed deep ensemble to achieve whatever level of inferencing accuracy is deemed sufficient with fewer student networks (e.g., with a minimum or approximately minimum number of student networks).

Various embodiments described herein can be employed to use hardware or software to solve problems that are highly technical in nature (e.g., to facilitate improved distillation of deep ensembles), that are not abstract and that cannot be performed as a set of mental acts by a human. Further, some of the processes performed can be performed by a specialized computer (e.g., a deep learning neural network having internal parameters such as convolutional kernels) for carrying out defined acts related to improved distillation of deep ensembles. For example, such defined acts can include: accessing, by a device operatively coupled to a processor, a deep learning ensemble configured to perform an inferencing task; and iteratively distilling, by the device, the deep learning ensemble into a smaller deep learning ensemble configured to perform the inferencing task, wherein a current distillation iteration can involve training a new neural network of the smaller deep learning ensemble via a loss function that is based on one or more neural networks of the smaller deep learning ensemble which were trained during one or more previous distillation iterations. In various aspects, such defined acts can further include: accessing, by the device, a training dataset on which the deep learning ensemble was trained, and the current distillation iteration can comprise: initializing, by the device, trainable internal parameters of the new neural network; selecting, by the device and from the training dataset, one or more training data candidates and one or more ground-truth annotations corresponding to the one or more training data candidates; executing, by the device, the new neural network on the one or more training data candidates, thereby yielding one or more first inferencing task outputs; executing, by the device, the deep learning ensemble on the one or more training data candidates, thereby yielding one or more second inferencing task outputs; updating, by the device and via backpropagation, the trainable internal parameters of the new neural network based on the loss function, wherein the loss function can include a first term that quantifies errors between the one or more first inferencing task outputs and the one or more ground-truth annotations, wherein the loss function can include a second term that quantifies errors between the one or more first inferencing task outputs and the one or more second inferencing task outputs, and wherein the loss function can include a third term that quantifies similarities between the new neural network and the one or more neural networks of the smaller deep learning ensemble which were trained during the one or more previous distillation iterations; and repeating, by the device, respective above acts until a training termination criterion associated with the new neural network is satisfied.

Such defined acts are not performed manually by humans. Indeed, neither the human mind nor a human with pen and paper can electronically access a deep ensemble and electronically distill the deep ensemble into a condensed deep ensemble, where each distillation iteration can involve training a new constituent neural network for the condensed deep ensemble based on the prior constituent neural networks that had been previously added to the condensed deep ensemble. Indeed, an ensemble of deep learning neural networks is an inherently-computerized construct that simply cannot be meaningfully implemented in any way by the human mind without computers. Similarly, knowledge distillation is an inherently computerized technique for reducing the size of deep ensembles that cannot be meaningfully performed in any way by the human mind without computers. Accordingly, a computerized tool that can perform knowledge distillation on a deep ensemble is likewise inherently-computerized and cannot be implemented in any sensible, practical, or reasonable way without computers.

Moreover, various embodiments described herein can integrate into a practical application various teachings relating to improved distillation of deep ensembles. As explained above, a deep ensemble can achieve high inferencing accuracy at the expense of having an excessively large computational footprint. To reduce such computational footprint, knowledge distillation can be implemented. Some existing techniques for performing knowledge distillation involve distilling a deep ensemble into a single neural network. Although these existing techniques can preserve accuracy while significantly reducing computational footprint, these existing techniques cannot support uncertainty quantification. Other existing techniques for performing knowledge distillation involve distilling a deep ensemble into a condensed deep ensemble. Such existing techniques allow computational footprint to be reduced and uncertainty to be quantified. However, such existing techniques operate by fixing the size (e.g., number of constituent neural networks) of the condensed deep ensemble a priori. Accordingly, it is possible that the fixed size of the condensed deep ensemble might be too big (in which case the condensed deep ensemble can achieve sufficiently high accuracy but can nevertheless be considered as having a larger-than-necessary footprint) or too small (in which case the condensed deep ensemble can have a significantly smaller footprint but can fail to achieve sufficiently high accuracy).

Various embodiments described herein can address one or more of these technical problems. Specifically, the present inventors devised various embodiments that can distill a deep ensemble into a condensed deep ensemble, which embodiments can cause the condensed deep ensemble to achieve sufficiently high accuracy while having a minimized or approximately minimized computational footprint. In particular, the present inventors realized that existing techniques' shortcomings can be at least partially caused by the fact that such existing techniques fix the size of a condensed deep ensemble and train its constituent neural networks independently of each other. As the present inventors recognized, such independent training can cause such constituent neural networks to become at least somewhat similar to, and thus redundant with, each other. Such redundancy can be considered as wasteful and unnecessarily increasing the computational footprint of the condensed deep ensemble. Equivalently, such redundancy can be considered as reducing a maximum amount of inferencing accuracy that can be achieved by the condensed deep ensemble at any given computational footprint size.

To address this issue, the present inventors devised various techniques, which can involve iteratively building the condensed deep ensemble one constituent neural network at a time, using a retrospective loss function that can enforce dissimilarity, and thus non-redundancy, across the condensed deep ensemble. In some cases, the retrospective loss function can enforce such non-redundancy via parameter-space cosine similarity computations. In other cases, the retrospective loss function can enforce such non-redundancy via feature-space Euclidean distance computations. In any case, the retrospective loss function can cause each newly-added constituent neural network to be dissimilar to (non-redundant with) each previously-added constituent neural network of the condensed deep ensemble. In various aspects, the condensed deep ensemble can be iteratively built in this fashion until a percentage change in the performance (e.g., test accuracy) of the condensed deep ensemble is below any suitable threshold margin. Generating the condensed deep ensemble in this way can cause the condensed deep ensemble to achieve comparable (or even better) inferencing accuracy as the original deep ensemble, while at the same time having as few constituent neural networks as feasible. Thus, accuracy can be preserved, uncertainty quantification can be preserved, and computational footprint can be minimized or approximately minimized by various embodiments described herein. Such embodiments certainly constitute concrete and tangible technical improvements in the field of deep ensembles, and such embodiments therefore clearly qualify as useful and practical applications of computers.

Furthermore, various embodiments described herein can control real-world tangible devices based on the disclosed teachings. For example, various embodiments described herein can electronically execute or train real-world deep learning neural networks that have been ensembled together.

It should be appreciated that the herein figures and description provide non-limiting examples of various embodiments and are not necessarily drawn to scale.

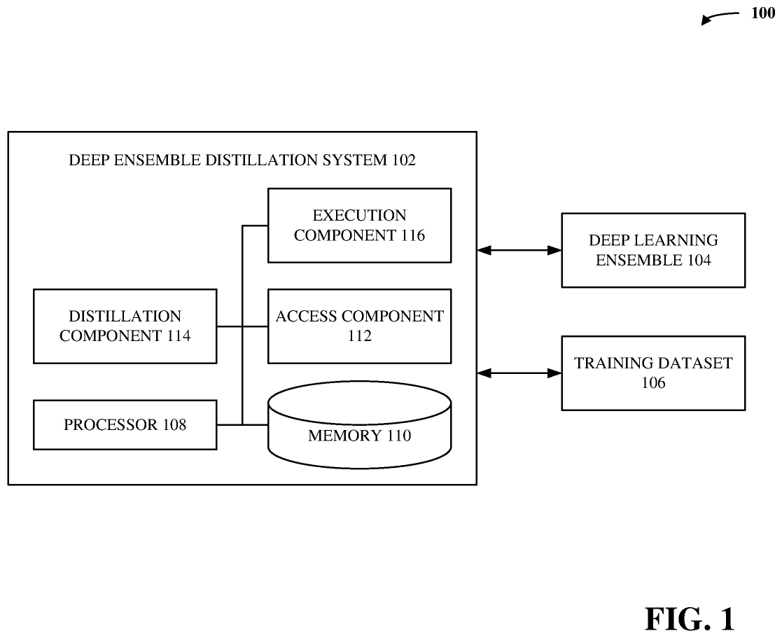

FIG. 1 illustrates a block diagram of an example, non-limiting system 100 that can facilitate improved distillation of deep ensembles in accordance with one or more embodiments described herein. As shown, a deep ensemble distillation system 102 can be electronically integrated, via any suitable wired or wireless electronic connections, with a deep learning ensemble 104 and with a training dataset 106.

In various embodiments, the deep learning ensemble 104 can be configured to perform an inferencing task on a data candidate. More specifically, the deep learning ensemble 104 can be a plurality of teacher neural networks, each of which can be configured to perform the inferencing task on the data candidate.

In various aspects, the data candidate can be any suitable electronic data having any suitable format, size, or dimensionality. In other words, the data candidate can be one or more scalars, one or more vectors, one or more matrices, one or more tensors, one or more character strings, or any suitable combination thereof. As a non-limiting example, the data candidate can be one or more two-dimensional images (e.g., one or more pixel arrays). As another non-limiting example, the data candidate can be one or more three-dimensional images (e.g., one or more voxel arrays). As yet another non-limiting example, the data candidate can be one or more electronic audio files (e.g., one or more timeseries of pressure values or decibel values). As still another non-limiting example, the data candidate can be waveform-spectra (e.g., data represented in a frequency-domain instead of a time-domain). As even another non-limiting example, the data candidate can be an electronic textual file (e.g., one or more strings of text). As another non-limiting example, the data candidate can be any suitable combination thereof.

In various instances, the inferencing task can be or otherwise involve computational generation of any suitable prediction or forecast for or with respect to a data candidate. As a non-limiting example, the inferencing task can be classification. In such case, the deep learning ensemble 104 can be configured to receive a particular data candidate as input and to produce as output a classification label for that particular data candidate. As another non-limiting example, the inferencing task can be segmentation. In such case, the deep learning ensemble 104 can be configured to receive a particular data candidate as input and to produce as output a segmentation mask for that particular data candidate. As even another non-limiting example, the inferencing task can be regression. In such case, the deep learning ensemble 104 can be configured to receive a particular data candidate as input and to produce as output a regression result for (e.g., a denoised version of, a resolution-enhanced version of, a continuously-variable scalar for) that particular data candidate. As yet another non-limiting example, the inferencing task can be any suitable combination of classification, segmentation, or regression.

In some embodiments, the deep learning ensemble 104 can be deployed or otherwise implemented in a medical or clinical operational context. In such cases, a data candidate can be a medical image (e.g., a computed tomography (CT) scanned image, a magnetic resonance imaging (MRI) scanned image, a positron emission tomography (PET) scanned image, an X-ray scanned image, an ultrasound scanned image) that depicts any suitable anatomical structure (e.g., tissue, organ, body part, or portion thereof) of a medical patient (e.g., human, animal, or otherwise), and the inferencing task can be any suitable classification, segmentation, or regression that can be leveraged for diagnostic or prognostic purposes. Accordingly, the deep learning ensemble 104 can, in such embodiments, be hosted on any suitable medical imaging or scanning device. As a non-limiting example, suppose that the deep learning ensemble 104 is configured to perform the inferencing task on CT scanned images. In such case, the deep learning ensemble 104 can be hosted on a CT scanner and can thus perform the inferencing task on CT scanned images captured or generated by the CT scanner. As another non-limiting example, suppose that the deep learning ensemble 104 is configured to perform the inferencing task on MRI scanned images. In such case, the deep learning ensemble 104 can be hosted on an MRI scanner and can thus perform the inferencing task on MRI scanned images captured or generated by the MRI scanner. As yet another non-limiting example, suppose that the deep learning ensemble 104 is configured to perform the inferencing task on PET scanned images. In such case, the deep learning ensemble 104 can be hosted on a PET scanner and can thus perform the inferencing task on PET scanned images captured or generated by the PET scanner. As still another non-limiting example, suppose that the deep learning ensemble 104 is configured to perform the inferencing task on X-ray scanned images. In such case, the deep learning ensemble 104 can be hosted on an X-ray scanner and can thus perform the inferencing task on X-ray scanned images captured or generated by the X-ray scanner. As even another non-limiting example, suppose that the deep learning ensemble 104 is configured to perform the inferencing task on ultrasound scanned images. In such case, the deep learning ensemble 104 can be hosted on an ultrasound scanner and can thus perform the inferencing task on ultrasound scanned images captured or generated by the ultrasound scanner.

In any case, the deep learning ensemble 104 can have been previously trained in supervised fashion to accurately perform the inferencing task on inputted data candidates. In various instances, the training dataset 106 can be a plurality of annotated data candidates on which the deep learning ensemble 104 was previously trained. However, this is a mere non-limiting example. In other instances, the training dataset 106 can be a plurality of annotated data candidates on which the deep learning ensemble 104 was not trained, but such plurality of annotated data candidates can collectively exhibit the same or similar feature distributions, property distributions, or attribute distributions as whatever data candidates that were used to previously train the deep learning ensemble 104.

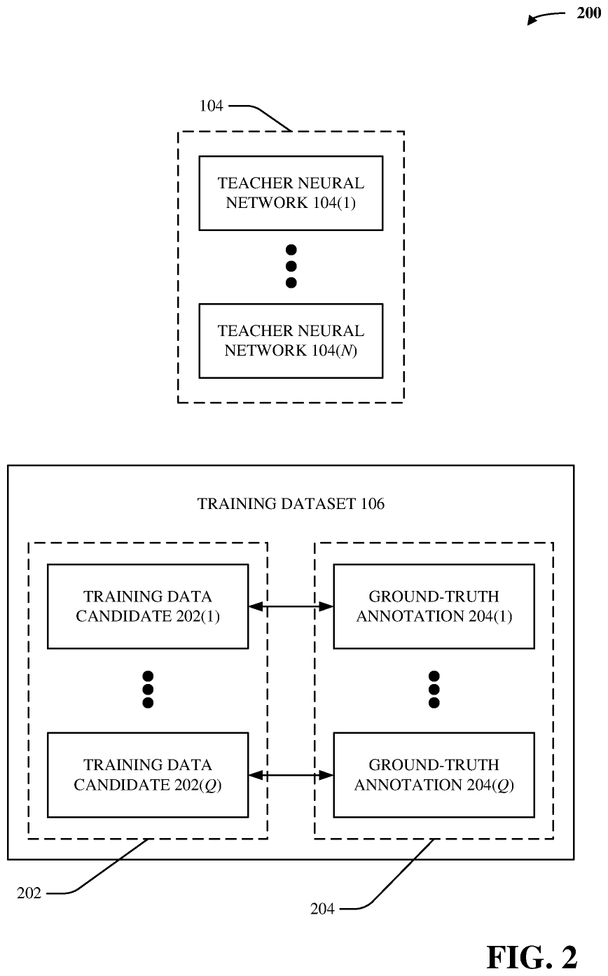

FIG. 2 illustrates an example, non-limiting block diagram 200 of the deep learning ensemble 104 and of the training dataset 106 in accordance with one or more embodiments described herein.

In various embodiments, as shown, the deep learning ensemble 104 can comprise a total of n teacher neural networks for any suitable positive integer n>2: a teacher neural network 104(1) to a teacher neural network 104(n). In various aspects, each teacher neural network of the deep learning ensemble 104 can have or otherwise exhibit any suitable deep learning internal architecture. For instance, a teacher neural network of the deep learning ensemble 104 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In some instances, different teacher neural networks within the deep learning ensemble 104 can have the same or different internal architectures as each other. In other words, any two teacher neural networks within the deep learning ensemble 104 can have the same or different numbers or arrangements of neural network layers or of trainable internal parameters as each other.

In various cases, the n teacher neural networks that make up the deep learning ensemble 104 can operate in parallel with each other. More specifically, suppose that there is a given data candidate on which it is desired to execute the deep learning ensemble 104. In such case, each of the n teacher neural networks that make up the deep learning ensemble 104 can be executed in parallel on the given data candidate. Such parallel execution can yield n individual inferencing task results (e.g., one individual inferencing task result per teacher neural network). As a non-limiting example, the teacher neural network 104(1) can be executed on the given data candidate, and such execution can cause the teacher neural network 104(1) to produce as output a first individual inferencing task result (e.g., a first classification label, a first segmentation mask, a first regression output). As another non-limiting example, the teacher neural network 104(n) can be executed on the given data candidate, and such execution can cause the teacher neural network 104(n) to produce as output an n-th individual inferencing task result (e.g., an n-th classification label, an n-th segmentation mask, an n-th regression output). In various aspects, such n individual inferencing task results can be combined (e.g., via weighted or non-weighted averaging) to yield an aggregated inferencing task result (e.g., an averaged classification label, an averaged segmentation mask, an averaged regression output). In any case, the aggregated inferencing task result can be considered as the prediction that is outputted by the deep learning ensemble 104 in response to receiving the given data candidate as input.

In various aspects, as shown, the training dataset 106 can comprise a set of training data candidates 202. In various instances, the set of training data candidates 202 can comprise q training data candidates for any suitable positive integer q: a training data candidate 202(1) to a training data candidate 202(q). In various cases, each of the set of training data candidates 202 can be any suitable data candidate that the deep learning ensemble 104 encountered during its previous training.

In various aspects, as also shown, the training dataset 106 can comprise a set of ground-truth annotations 204. In various instances, the set of ground-truth annotations 204 can respectively correspond (e.g., in one-to-one fashion) to the set of training data candidates 202. Accordingly, since the set of training data candidates 202 can include q training data candidates, the set of ground-truth annotations 204 can comprise q ground-truth annotations: a ground-truth annotation 204(1) to a ground-truth annotation 204(q). In various cases, each of the set of ground-truth annotations 204 can be any suitable electronic data having any suitable format, size, or dimensionality (e.g., can be one or more scalars, one or more vectors, one or more matrices, one or more tensors, one or more character strings, or any suitable combination thereof) which can indicate or otherwise represent a correct or accurate inferencing task result that is known or otherwise deemed to correspond to a respective one of the set of training data candidates 202.

As a non-limiting example, the ground-truth annotation 204(1) can correspond to the training data candidate 202(1). Accordingly, the ground-truth annotation 204(1) can be considered as being, indicating, or otherwise representing whatever correct or accurate inferencing task result (e.g., correct or accurate classification label, correct or accurate segmentation mask, correct or accurate regression output) that is known or deemed to correspond to the training data candidate 202(1).

As another non-limiting example, the ground-truth annotation 204(q) can correspond to the training data candidate 202(q). Accordingly, the ground-truth annotation 204(q) can be considered as being, indicating, or otherwise representing whatever correct or accurate inferencing task result (e.g., correct or accurate classification label, correct or accurate segmentation mask, correct or accurate regression output) that is known or deemed to correspond to the training data candidate 202(q).

In various aspects, each of the teacher neural networks that make up the deep learning ensemble 104 can have been trained on the training dataset 106 (or on different or disjoint subsets thereof) via a unique random initialization of trainable internal parameters. As a non-limiting example, the trainable internal parameters of the teacher neural network 104(1) can have been randomly initialized so as to have unique initial values, and the teacher neural network 104(1) can then have been trained in supervised fashion on the training dataset 106 (or on a portion thereof). As another non-limiting example, the trainable internal parameters of the teacher neural network 104(n) can have been randomly initialized so as to have unique initial values (e.g., initial values that do not identically match the initial values of the teacher neural network 104(1)), and the teacher neural network 104(n) can then have been trained in supervised fashion on the training dataset 106 (or on some portion thereof).

Referring back to FIG. 1, it can be the case that the deep learning ensemble 104 has an excessively large computational footprint (e.g., consumes too much memory space, processing capacity, or inferencing time). Accordingly, it can be desired to distill the deep learning ensemble 104 into a smaller deep learning ensemble, where such smaller deep learning ensemble can exhibit a minimized or approximately minimized computational footprint that nevertheless achieves comparable inferencing accuracy as the deep learning ensemble 104. As described herein, the deep ensemble distillation system 102 can facilitate such distillation, based on the deep learning ensemble 104 and based on the training dataset 106.

In various embodiments, the deep ensemble distillation system 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components of the deep ensemble distillation system 102 (e.g., access component 112, distillation component 114, execution component 116) to perform one or more acts. In various embodiments, the non-transitory computer-readable memory 110 can store computer-executable components (e.g., access component 112, distillation component 114, execution component 116), and the processor 108 can execute the computer-executable components.

In various embodiments, the deep ensemble distillation system 102 can comprise an access component 112. In various aspects, the access component 112 can electronically receive or otherwise electronically access the deep learning ensemble 104 or the training dataset 106. In various instances, the access component 112 can electronically retrieve the deep learning ensemble 104 or the training dataset 106 from any suitable centralized or decentralized data structures (not shown) or from any suitable centralized or decentralized computing devices (not shown). In any case, the access component 112 can electronically obtain or access the deep learning ensemble 104 or the training dataset 106, such that other components of the deep ensemble distillation system 102 can electronically interact with the deep learning ensemble 104 or with the training dataset 106.

In various embodiments, the deep ensemble distillation system 102 can comprise a distillation component 114. In various aspects, as described herein, the distillation component 114 can electronically, and in an iterative fashion, distill the deep learning ensemble 104 into a condensed deep learning ensemble. In various cases, the distillation component 114 can facilitate such iterative distillation via a retrospective loss function and via an ensemble saturation threshold.

In various embodiments, the deep ensemble distillation system 102 can comprise an execution component 116. In various instances, as described herein, the execution component 116 can electronically deploy the condensed deep learning ensemble in any suitable operational or clinical context.

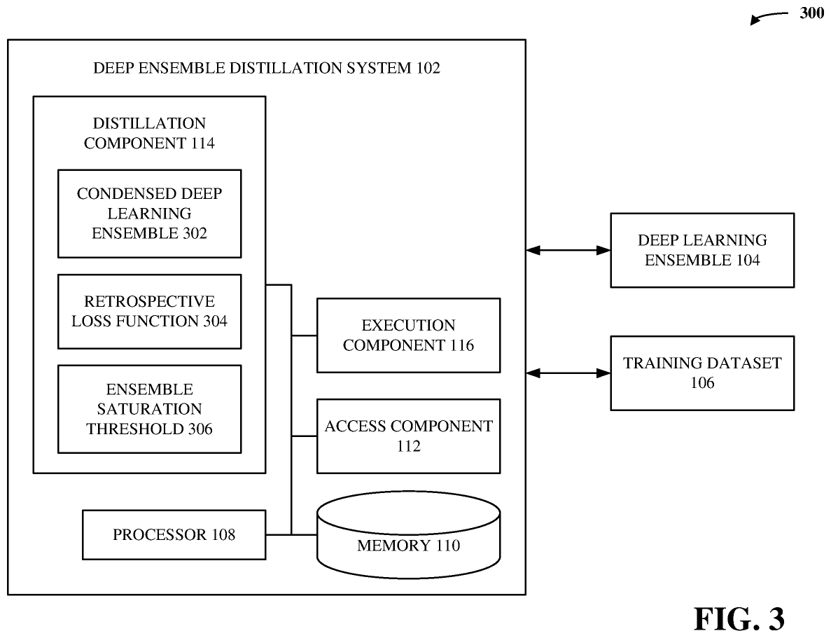

FIG. 3 illustrates a block diagram of an example, non-limiting system 300 including a condensed deep ensemble, a retrospective loss function, and an ensemble saturation threshold that can facilitate improved distillation of deep ensembles in accordance with one or more embodiments described herein. As shown, the system 300 can, in some cases, comprise the same components as the system 100, and can further comprise a condensed deep learning ensemble 302, a retrospective loss function 304, and an ensemble saturation threshold 306.

In various embodiments, the distillation component 114 can electronically generate the condensed deep learning ensemble 302, based on: the deep learning ensemble 104; the training dataset 106; the retrospective loss function 304; and the ensemble saturation threshold 306. In particular, the condensed deep learning ensemble 302 can begin as an empty set, and the distillation component 114 can add student neural networks (e.g., one student neural network at a time) to the condensed deep learning ensemble 302 via any suitable number of knowledge distillation iterations. During each knowledge distillation iteration, a newly-added student neural network can be randomly initialized and can be trained on the training dataset 106 using the retrospective loss function 304 as a backpropagation driver. Once the newly-added student neural network is trained, the distillation component 114 can determine whether to begin a next knowledge distillation iteration by comparing a percentage change in a performance metric (e.g., test accuracy) of the condensed deep learning ensemble 302 against the ensemble saturation threshold 306.

Note that, per knowledge distillation nomenclature, the constituent neural networks that make up the deep learning ensemble 104 can be referred to as teachers (hence the term “teacher neural network”), and the constituent neural networks that make up the condensed deep learning ensemble 302 can be referred to as students (hence the term “student neural network”).

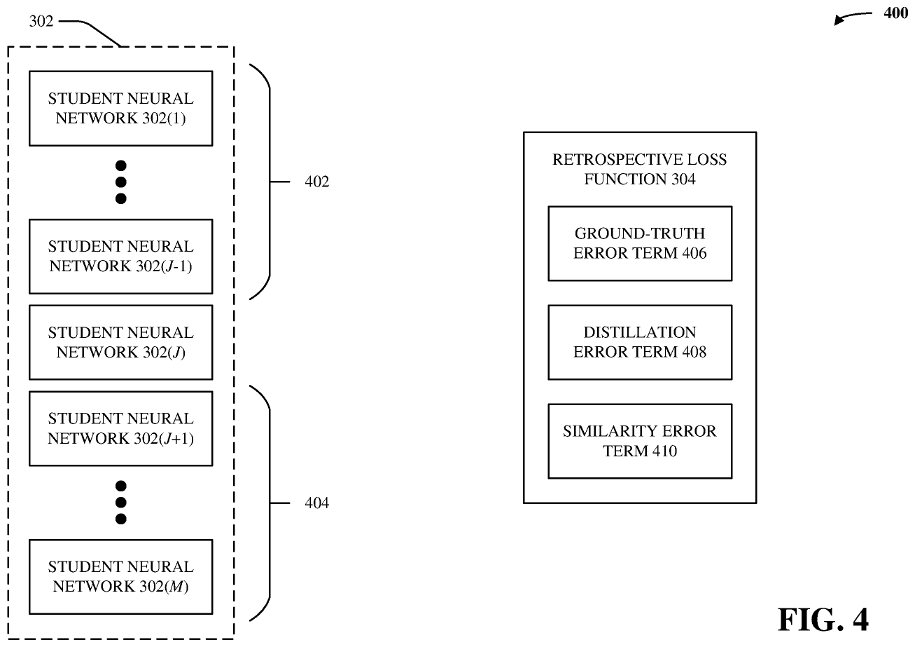

Various non-limiting aspects regarding how the distillation component 114 can generate the condensed deep learning ensemble 302 are further described with respect to FIGS. 4-11.

FIG. 4 illustrates an example, non-limiting block diagram 400 of the condensed deep learning ensemble 302 and of the retrospective loss function 304 in accordance with one or more embodiments described herein.

In various embodiments, as shown, the condensed deep learning ensemble 302 can comprise a total of m student neural networks for any suitable positive integer 1<m<n: a student neural network 302(1) to a student neural network 302(m). In other words, the condensed deep learning ensemble 302 can have a smaller cardinality (e.g., can contain fewer constituent neural networks) than the deep learning ensemble 104. In various aspects, each student neural network of the condensed deep learning ensemble 302 can have or otherwise exhibit any suitable deep learning internal architecture. For instance, a student neural network of the condensed deep learning ensemble 302 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In some instances, different student neural networks within the condensed deep learning ensemble 302 can have the same internal architectures as each other. In other words, all m of the student neural networks within the condensed deep learning ensemble 302 can have the same numbers and arrangements of neural network layers and of trainable internal parameters as each other.

In various aspects, each student neural network of the condensed deep learning ensemble 302 can have the same or smaller internal architecture as the smallest teacher neural network of the deep learning ensemble 104. In other words, there can be a teacher neural network of the deep learning ensemble 104 that can be considered as having the fewest number of neural network layers or the fewest trainable internal parameters, and each student neural network of the condensed deep learning ensemble 302 can have the same or fewer numbers of neural network layers or of trainable internal parameters as that teacher neural network.

Because the condensed deep learning ensemble 302 can have a smaller cardinality than the deep learning ensemble 104, and because each student neural network can have the same or smaller internal architecture as the smallest teacher neural network, the condensed deep learning ensemble 302 can be considered as exhibiting a smaller computational footprint than the deep learning ensemble 104. That is, it can take less computer memory space to store the condensed deep learning ensemble 302 than to the store the deep learning ensemble 104; it can take less computer processing capacity to execute the condensed deep learning ensemble 302 than to execute the deep learning ensemble 104; and it can take less time to execute the condensed deep learning ensemble 302 than to execute the deep learning ensemble 104.

Although FIG. 4 illustrates the condensed deep learning ensemble 302 as comprising a total of m student neural networks, this can be after the distillation component 114 has finished generating the condensed deep learning ensemble 302. Indeed, in various aspects, the condensed deep learning ensemble 302 can begin as an empty set (e.g., as having no student neural networks), and the distillation component 114 can iteratively build the condensed deep learning ensemble 302 by adding a new student network during each knowledge distillation iteration. More specifically, during any given knowledge distillation iteration, the distillation component 114 can randomly initialize the internal parameters of a new student neural network, the distillation component 114 can train that new student neural network on the training dataset 106 using the retrospective loss function 304, and the distillation component 114 can determine whether to proceed to a next knowledge distillation iteration by evaluating whether or not the new student neural network has improved performance of the condensed deep learning ensemble 302 by at least the ensemble saturation threshold 306.

As a non-limiting example, since the condensed deep learning ensemble 302 can comprise a total of m student neural networks, the distillation component 114 can perform a total of m knowledge distillation iterations. In various aspects, during a j-th knowledge distillation iteration for any suitable positive integer j≤m, the distillation component 114 can add a student neural network 302(j) to the condensed deep learning ensemble 302. During such j-th knowledge distillation iteration, the condensed deep learning ensemble 302 can be considered as having a total of (j−1) previously-added student neural networks: the student neural network 302(1) to a student neural network 302(j−1). In other words, during such j-th knowledge distillation iteration, the condensed deep learning ensemble 302 can be considered as not yet having a student neural network 302(j+1) to the student neural network 302(m).

For ease of illustration and explanation, the student neural network 302(1) to the student neural network 302(j) can be referred to as a condensed ensemble subset 402, and the student neural network 302(j+1) to the student neural network 302(m) can be referred to as a condensed ensemble subset 404.

Note that, if j=1, the condensed ensemble subset 402 can be empty. In other words, the condensed deep learning ensemble 302 can be considered as having no previously-added student neural networks during the first knowledge distillation iteration. Additionally, note that, if j=m, there can be no student neural network 302(j+1), and the condensed ensemble subset 404 can be empty. In other words, the condensed deep learning ensemble 302 can be considered as being finished or otherwise completely constructed or generated after performance of the m-th knowledge distillation iteration.

For ease of illustration and explanation, the remainder of FIG. 4 and FIGS. 5-11 can be considered as concerning how the j-th knowledge distillation iteration can proceed.

In various aspects, at the start of the j-th knowledge distillation iteration, the condensed deep learning ensemble 302 can be considered as having undergone a total of (j−1) previous knowledge distillation iterations. Thus, at the start of the j-th knowledge distillation iteration, the condensed deep learning ensemble 302 can be considered as having a total of (j−1) student neural networks, each of which has been trained during its respective knowledge distillation iteration.

In various aspects, during the j-th knowledge distillation iteration, the distillation component 114 can insert into the condensed deep learning ensemble 302 the student neural network 302(j), where the student neural network 302(j) can have trainable internal parameters (e.g., weight matrices, biases, convolutional kernels) that have been randomly initialized. At such point, the condensed deep learning ensemble 302 can be considered as having a total of j student neural networks, where (j−1) of them have been trained and where the most recently-added one has not yet been trained.

In various instances, during the j-th knowledge distillation iteration, the distillation component 114 can electronically train the student neural network 302(j) on the training dataset 106, and such training can involve incrementally updating (e.g., via backpropagation) the trainable internal parameters of the student neural network 302(j) according to the retrospective loss function 304. In various cases, as shown, the retrospective loss function 304 can be considered as comprising three distinct terms: a ground-truth error term 406; a distillation error term 408; and a similarity error term 410. In other words, the retrospective loss function 304 can be considered as being any suitable additive, multiplicative, or exponential combination of the ground-truth error term 406, of the distillation error term 408, and of the similarity error term 410.

In various aspects, the ground-truth error term 406 can be any suitable numerical error or numerical loss that can quantify how well or how poorly the student neural network 302(j) is able to predict ground-truth annotations specified in the training dataset 106. In various instances, the distillation error term 408 can be any suitable numerical error or numerical loss that can quantify how well or how poorly the student neural network 302(j) is able to emulate predictions generated by the deep learning ensemble 104. In various cases, the similarity error term 410 can be any suitable numerical error or numerical loss that can quantify how similar or dissimilar the student neural network 302(j) is with respect to each of the (j−1) student neural networks that had previously been inserted into the condensed deep learning ensemble 302 (e.g., with respect to each of the condensed ensemble subset 402).

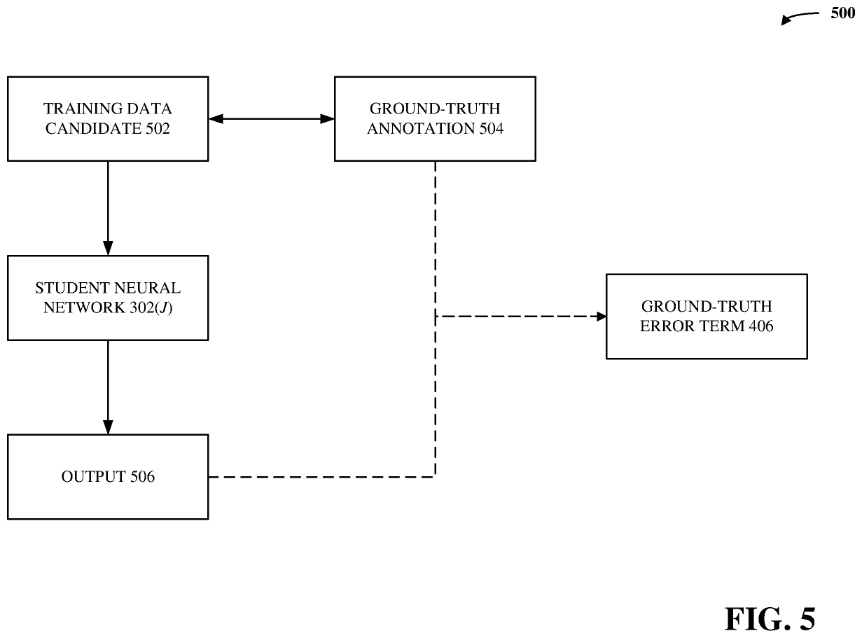

Various non-limiting aspects regarding how the distillation component 114 can compute the retrospective loss function 304 are described with respect to FIGS. 5-10.

First, consider FIG. 5. FIG. 5 illustrates an example, non-limiting block diagram 500 showing how the ground-truth error term 406 of the retrospective loss function 304 can be obtained in accordance with one or more embodiments described herein.

In various aspects, during the j-th knowledge distillation iteration and after randomly initializing the trainable internal parameters of the student neural network 302(j), the distillation component 114 can select from the training dataset 106 a training data candidate 502 and a ground-truth annotation 504 that corresponds to the training data candidate 502. In various instances, the distillation component 114 can execute the student neural network 302(j) on the training data candidate 502, which can cause the student neural network 302(j) to produce an output 506. More specifically, the distillation component 114 can feed the training data candidate 502 to an input layer of the student neural network 302(j), the training data candidate 502 can complete a forward pass through one or more hidden layers of the student neural network 302(j), and an output layer of the student neural network 302(j) can compute the output 506 based on activation maps generated by the one or more hidden layers of the student neural network 302(j).

Note that, in various cases, the format, size, or dimensionality of the output 506 can be controlled by or can otherwise depend upon the number or arrangement of neurons or of trainable internal parameters (e.g., convolutional kernels, weight matrices) that are in the output layer of the student neural network 302(j). That is, the output 506 can be forced to have a desired format, size, or dimensionality by controllably adding or removing neurons or other trainable internal parameters to or from the output layer of the student neural network 302(j).

In any case, the output 506 can be considered as the predicted inferencing task result (e.g., predicted classification label, predicted segmentation mask, predicted regression output) that the student neural network 302(j) has determined corresponds to the training data candidate 502. In contrast, the ground-truth annotation 504 can be considered as the correct or accurate inferencing task result (e.g., correct or accurate classification label, correct or accurate segmentation mask, correct or accurate regression output) that is known or deemed to correspond to the training data candidate 502. Note that, if the student neural network 302(j) has so far undergone no or little training, then the output 506 can be very inaccurate (e.g., can be very different from the ground-truth annotation 504).

In various aspects, the distillation component 114 can compute the ground-truth error term 406 based on the output 506 and based on the ground-truth annotation 504. In particular, the ground-truth error term 406 can be any suitable error or loss between the output 506 and the ground-truth annotation 504. As a non-limiting example, the ground-truth error term 406 can be equal to or otherwise based on a mean absolute error between the output 506 and the ground-truth annotation 504. As another non-limiting example, the ground-truth error term 406 can be equal to or otherwise based on a mean squared error between the output 506 and the ground-truth annotation 504. As even another non-limiting example, the ground-truth error term 406 can be equal to or otherwise based on a cross-entropy error between the output 506 and the ground-truth annotation 504. As still another non-limiting example, the ground-truth error term 406 can be equal to or otherwise based on a Kullback-Leibler divergence loss between the output 506 and the ground-truth annotation 504. In any case, the ground-truth error term 406 can be considered as representing or quantifying how accurately or how inaccurately the student neural network 302(j) was able to analyze the training data candidate 502.

Using mathematical notation, the ground-truth error term 406 during the j-th knowledge distillation iteration can, in a non-limiting embodiment, be represented as follows:

$$α * \frac{1}{b} {\sum }_{k = 1}^{b} {L}_{C E} ( \{ {f}_{{ϕ}_{j}} ( {x}_{k} ) , {y}_{k} \} )$$

where α can be any suitable hyperparameter, where b can be a size of a training batch, where L_{CE} can denote a cross-entropy loss function, where xx can be a k-th training data candidate in the training batch, where yk can be a k-th ground-truth annotation in the training batch, and where f_{ϕ}_{ⱼ} (xₖ) can denote the outputted prediction produced by the student neural network 302(j) in response to being executed on xₖ.

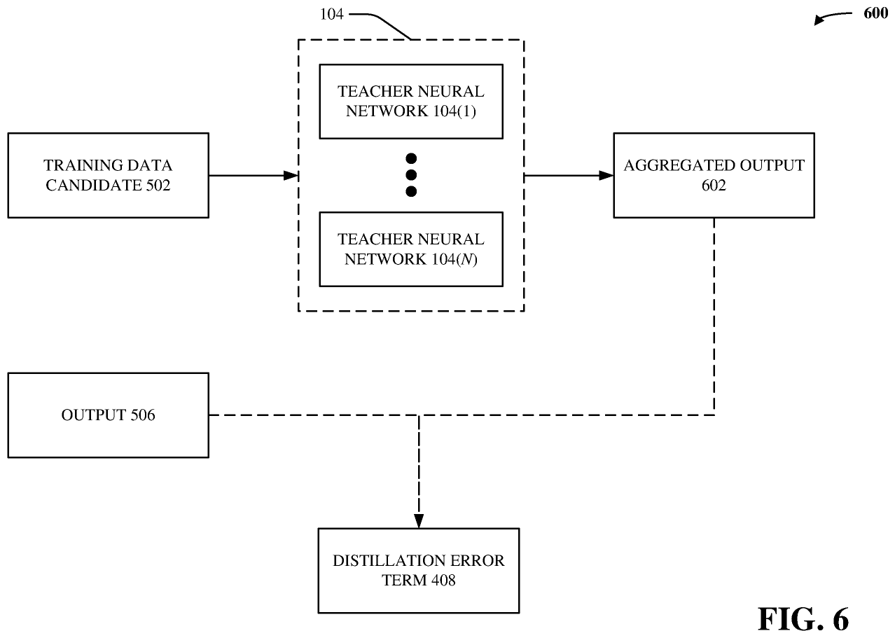

Now, consider FIG. 6. FIG. 6 illustrates an example, non-limiting block diagram 600 showing how the distillation error term 408 of the retrospective loss function 304 can be obtained in accordance with one or more embodiments described herein.

In various aspects, during the j-th knowledge distillation iteration, the distillation component 114 can execute the deep learning ensemble 104 on the training data candidate 502, which can cause the deep learning ensemble 104 to produce an aggregated output 602. More specifically, the distillation component 114 can execute each of the n teacher neural networks that make up the deep learning ensemble 104 on the training data candidate 502, thereby yielding a total of n individual outputs (not shown).

As a non-limiting example, the distillation component 114 can feed the training data candidate 502 to an input layer of the teacher neural network 104(1), the training data candidate 502 can complete a forward pass through one or more hidden layers of the teacher neural network 104(1), and an output layer of the teacher neural network 104(1) can compute a first individual output based on activation maps generated by the one or more hidden layers of the teacher neural network 104(1). Such first individual output can be considered as a first predicted inferencing task result (e.g., a first predicted classification label, a first predicted segmentation mask, a first predicted regression output) that the teacher neural network 104(1) has determined corresponds to the training data candidate 502.

As another non-limiting example, the distillation component 114 can feed the training data candidate 502 to an input layer of the teacher neural network 104(n), the training data candidate 502 can complete a forward pass through one or more hidden layers of the teacher neural network 104(n), and an output layer of the teacher neural network 104(n) can compute an n-th individual output based on activation maps generated by the one or more hidden layers of the teacher neural network 104(n). Such n-th individual output can be considered as an n-th predicted inferencing task result (e.g., an n-th predicted classification label, an n-th predicted segmentation mask, an n-th predicted regression output) that the teacher neural network 104(n) has determined corresponds to the training data candidate 502.

In any case, the aggregated output 602 can be equal to or otherwise based on a combination (e.g., a weighted or non-weighted average) of such n individual outputs. Accordingly, the aggregated output 602 can be considered as an averaged or overall inferencing task result (e.g., averaged or overall classification label, averaged or overall segmentation mask, averaged or overall regression output) that the deep learning ensemble 104 has collectively determined should correspond to the training data candidate 502.

In various aspects, the distillation component 114 can compute the distillation error term 408 based on the output 506 and based on the aggregated output 602. In particular, the distillation error term 408 can be any suitable error or loss between the output 506 and the aggregated output 602. As a non-limiting example, the distillation error term 408 can be equal to or otherwise based on a mean absolute error between the output 506 and the aggregated output 602. As another non-limiting example, the distillation error term 408 can be equal to or otherwise based on a mean squared error between the output 506 and the aggregated output 602. As even another non-limiting example, the distillation error term 408 can be equal to or otherwise based on a cross-entropy error between the output 506 and the aggregated output 602. As still another non-limiting example, the distillation error term 408 can be equal to or otherwise based on a Kullback-Leibler divergence loss between the output 506 and the aggregated output 602. In any case, the distillation error term 408 can be considered as representing or quantifying how closely the student neural network 302(j) was able to match or emulate the inferencing behavior of the deep learning ensemble 104 with respect to the training data candidate 502.

Using mathematical notation, the distillation error term 408 during the j-th knowledge distillation iteration can, in a non-limiting embodiment, be represented as follows:

$$( 1 - α ) \frac{1}{b} {\sum }_{k = 1}^{b} {L}_{K D} ( \{ {f}_{θ} ( {x}_{k} ) , {f}_{{ϕ}_{j}} ( {x}_{k} ) \} )$$

where a, b, xₖ, and f_{ϕ}_{ⱼ}(xₖ) can be as described above, where L_{KD} can denote a temperature-normalized Kullback-Leibler divergence loss function, and where f_{θ}(xₖ) can denote the aggregated outputted prediction produced by the deep learning ensemble 104 in response to being executed on xₖ.

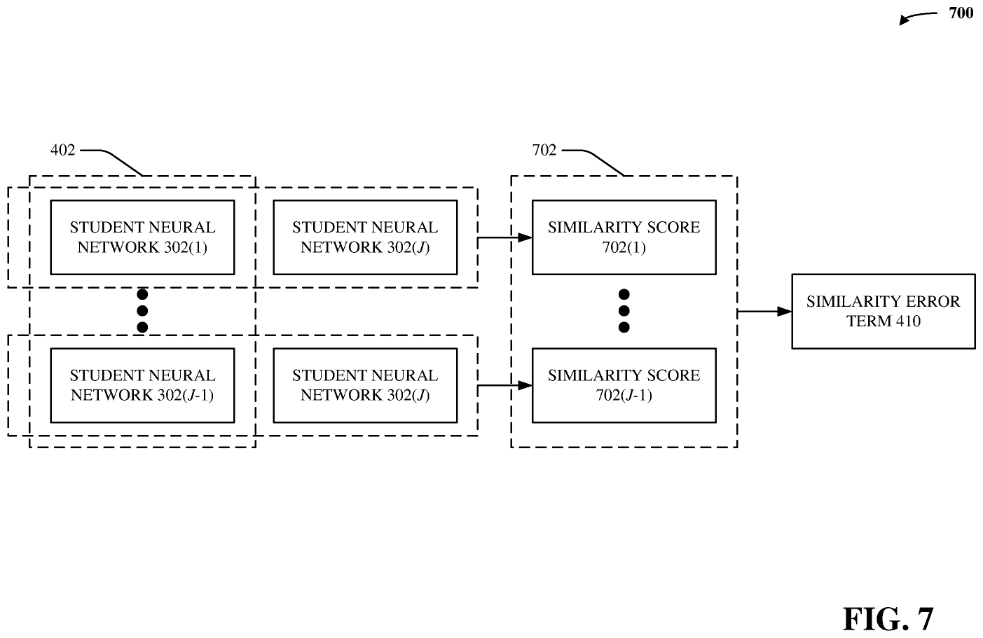

Now, consider FIG. 7. FIG. 7 illustrates an example, non-limiting block diagram 700 showing how the similarity error term 410 of the retrospective loss function 304 can be obtained in accordance with one or more embodiments described herein.

In various aspects, during the j-th knowledge distillation iteration, the distillation component 114 can compute a similarity score between the student neural network 302(j) and each of the (j−1) other student neural networks that had previously been added to the condensed deep learning ensemble 302. In other words, the distillation component 114 can compare the student neural network 302(j) to each student neural network in the condensed ensemble subset 402, and such comparisons can yield a set of similarity scores 702. Because the condensed ensemble subset 402 can comprise (j−1) student neural networks, the set of similarity scores 702 can likewise comprise (j−1) similarity scores: a similarity score 702(1) to a similarity score 702(j−1).

As a non-limiting example, the distillation component 114 can compare the student neural network 302(j) to the student neural network 302(1), and such comparison can yield the similarity score 702(1). In various aspects, the similarity score 702(1) can be one or more scalars, one or more vectors, one or more matrices, or one or more tensors that can indicate or otherwise represent how similar (e.g., how redundant) the student neural network 302(j) is to the student neural network 302(1).

As another non-limiting example, the distillation component 114 can compare the student neural network 302(j) to the student neural network 302(j−1), and such comparison can yield the similarity score 702(j−1). Just as above, the similarity score 702(j−1) can be one or more scalars, one or more vectors, one or more matrices, or one or more tensors that can indicate or otherwise represent how similar (e.g., how redundant) the student neural network 302(j) is to the student neural network 302(j−1).

In any case, the distillation component 114 can compute the similarity error term 410 based on the set of similarity scores 702. As a non-limiting example, the similarity error term 410 can be equal to otherwise based on any suitable additive, multiplicative, or exponential combination of the set of similarity scores 702 (e.g., the similarity error term 410 can be equal to the sum of the set of similarity scores 702; the similarity error term 410 can be equal to a weighted or non-weighted average of the set of similarity scores 702).

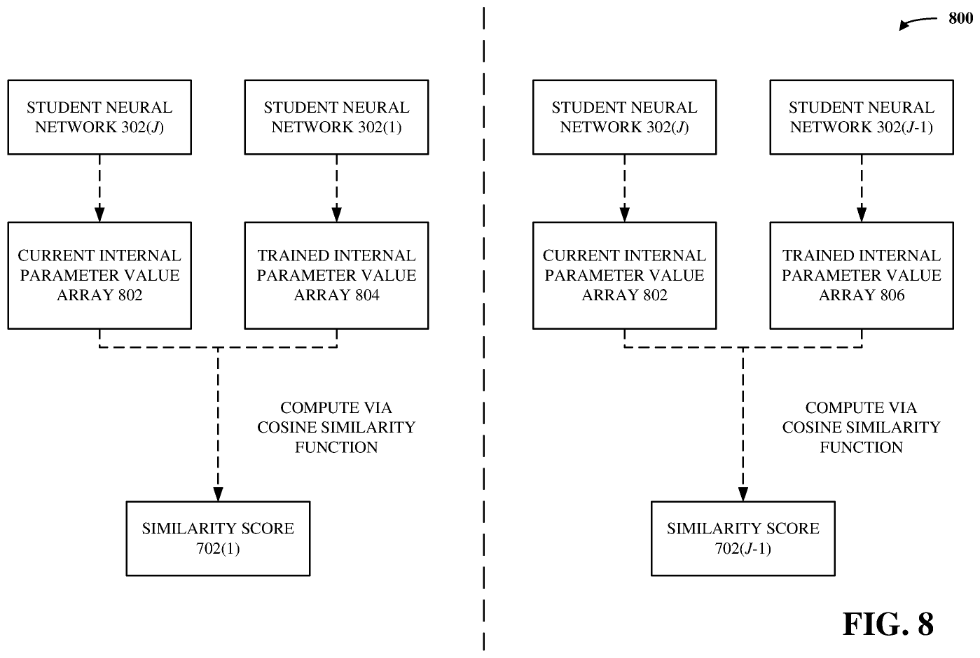

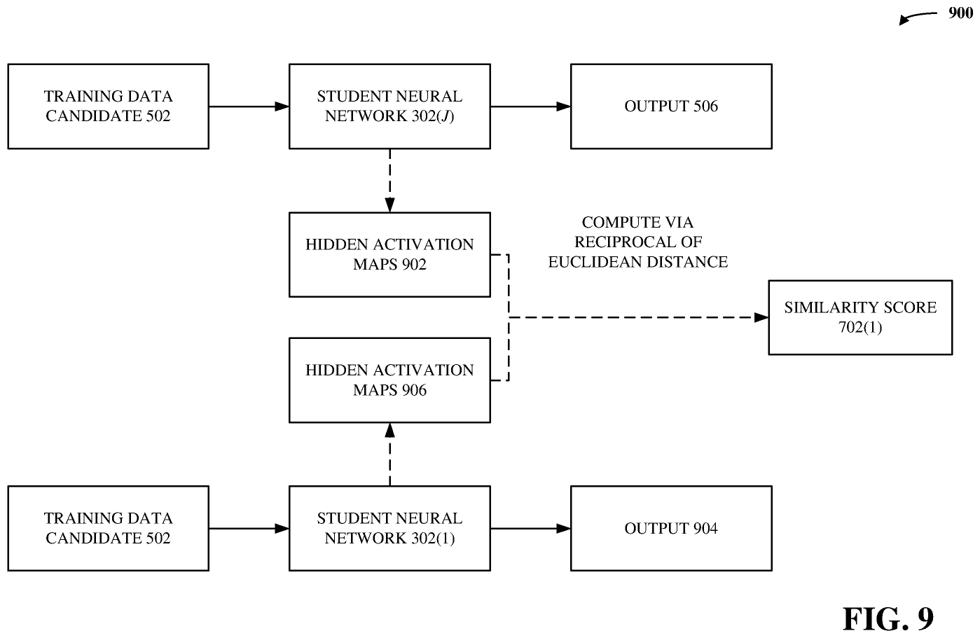

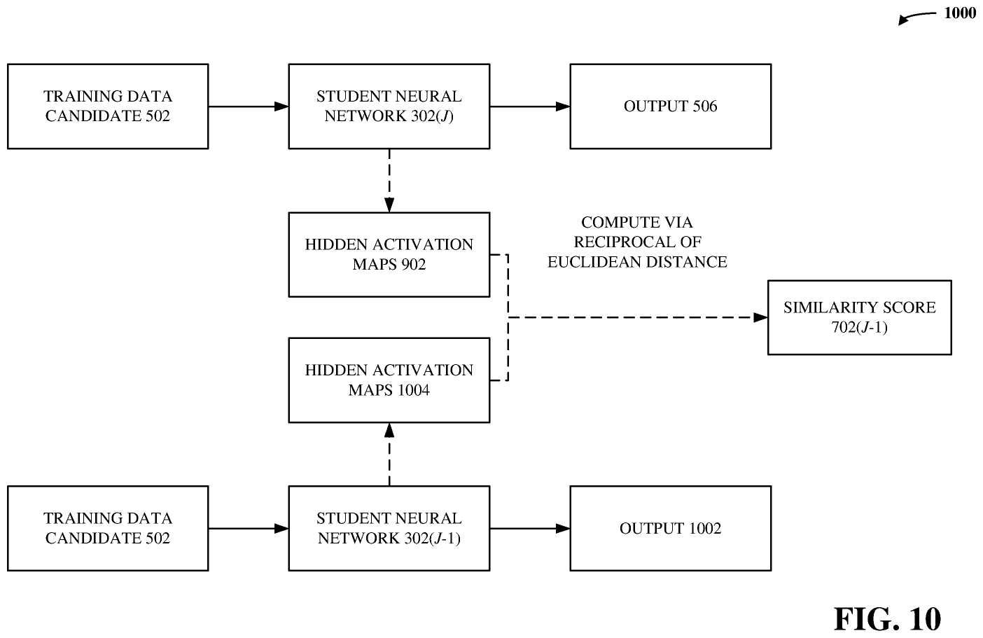

In some cases, the set of similarity scores 702 can be computed in a parameter-space of the student neural network 302(j), as shown with respect to FIG. 8. In other cases, the set of similarity scores 702 can be computed in a feature-space of the student neural network 302(j), as shown with respect to FIGS. 9-10.

FIG. 8 illustrates an example, non-limiting block diagram 800 showing how the similarity error term 410 of the retrospective loss function 304 can be obtained in a parameter-space of the student neural network 302(j) in accordance with one or more embodiments described herein.

In various embodiments, the student neural network 302(j) can be considered as corresponding to or otherwise being associated with a current internal parameter value array 802. In various aspects, the current internal parameter value array 802 can be one or more scalars, one or more vectors, one or more matrices, one or more tensors, or any suitable combination thereof whose numerical elements can indicate or otherwise specify values or magnitudes that are currently assigned to the various trainable internal parameters of the student neural network 302(j). As a non-limiting example, the student neural network 302(j) can have any suitable trainable weight matrices, and the current internal parameter value array 802 can indicate or specify numerical values that are currently respectively assigned to those trainable weight matrices. As another non-limiting example, the student neural network 302(j) can have any suitable trainable biases, and the current internal parameter value array 802 can indicate or specify numerical values that are currently respectively assigned to those trainable biases. As yet another non-limiting example, the student neural network 302(j) can have any suitable trainable convolutional kernels, and the current internal parameter value array 802 can indicate or specify numerical values that are currently respectively assigned to those trainable convolutional kernels. As still another non-limiting example, the student neural network 302(j) can have any suitable trainable scaling factors or shifting factors, and the current internal parameter value array 802 can indicate or specify numerical values that are currently respectively assigned to those trainable scaling factors or shifting factors.

In some cases, the current internal parameter value array 802 can be considered as indicating or otherwise specifying whatever values all the trainable internal parameters of the student neural network 302(j) currently have. In other cases, the current internal parameter value array 802 can be considered as indicating or otherwise specifying whatever values fewer than all of the trainable internal parameters of the student neural network 302(j) currently have (e.g., can specify the values of only those trainable internal parameters that are in one or more particular layers of the student neural network 302(j)).

Similarly, in various aspects, the student neural network 302(1) can be considered as corresponding to or otherwise being associated with a trained internal parameter value array 804. In various aspects, the trained internal parameter value array 804 can be one or more scalars, one or more vectors, one or more matrices, one or more tensors, or any suitable combination thereof whose numerical elements can indicate or otherwise specify finalized values or magnitudes that were assigned to the various trainable internal parameters of the student neural network 302(1) as a result of the student neural network 302(1) being trained during a previous knowledge distillation iteration (e.g., during the first knowledge distillation iteration). As a non-limiting example, the student neural network 302(1) can have any suitable trainable weight matrices, and the trained internal parameter value array 804 can indicate or specify numerical values that were respectively assigned to those trainable weight matrices at the termination of training of the student neural network 302(1). As another non-limiting example, the student neural network 302(1) can have any suitable trainable biases, and the trained internal parameter value array 804 can indicate or specify numerical values that were respectively assigned to those trainable biases at the termination of training of the student neural network 302(1). As yet another non-limiting example, the student neural network 302(1) can have any suitable trainable convolutional kernels, and the trained internal parameter value array 804 can indicate or specify numerical values that were respectively assigned to those trainable convolutional kernels at the termination of training of the student neural network 302(1). As still another non-limiting example, the student neural network 302(1) can have any suitable trainable scaling factors or shifting factors, and the trained internal parameter value array 804 can indicate or specify numerical values that were respectively assigned to those trainable scaling factors or shifting factors at the termination of training of the student neural network 302(1).

Just as above, in some cases, the trained internal parameter value array 804 can be considered as indicating or otherwise specifying whatever values all of the trainable internal parameters of the student neural network 302(1) have. In other cases, the trained internal parameter value array 804 can be considered as indicating or otherwise specifying whatever values fewer than all of the trainable internal parameters of the student neural network 302(1) have (e.g., can specify the values of only those trainable internal parameters that are in one or more particular layers of the student neural network 302(1)).

In various aspects, the current internal parameter value array 802 and the trained internal parameter value array 804 can have the same format, size, or dimensionality as each other. Thus, in various instances, the distillation component 114 can compute the similarity score 702(1) by applying a cosine similarity function to the current internal parameter value array 802 and to the trained internal parameter value array 804. In other words, the current internal parameter value array 802 and the trained internal parameter value array 804 can both be considered as high-dimensional vectors, and the similarity score 702(1) can be equal to or otherwise based on a cosine similarity between such high-dimensional vectors. In such case, higher values (e.g., closer to 1) of the similarity score 702(1) can be considered as indicating a higher degree of similarity, and thus a higher degree of redundancy, between the trainable internal parameters of the student neural network 302(j) and those of the student neural network 302(1). In contrast, lower values (e.g., closer to 0) of the similarity score 702(1) can be considered as indicating a lower degree of similarity, and thus a lower degree of redundancy, between the trainable internal parameters of the student neural network 302(j) and those of the student neural network 302(1).

Likewise, in various instances, the student neural network 302(j−1) can be considered as corresponding to or otherwise being associated with a trained internal parameter value array 806. In various aspects, the trained internal parameter value array 806 can be one or more scalars, one or more vectors, one or more matrices, one or more tensors, or any suitable combination thereof whose numerical elements can indicate or otherwise specify finalized values or magnitudes that were assigned to the various trainable internal parameters of the student neural network 302(j−1) as a result of the student neural network 302(j−1) being trained during a previous knowledge distillation iteration (e.g., during the (j−1)-th knowledge distillation iteration). As a non-limiting example, the student neural network 302(j−1) can have any suitable trainable weight matrices, and the trained internal parameter value array 806 can indicate or specify numerical values that were respectively assigned to those trainable weight matrices at the termination of training of the student neural network 302(j−1). As another non-limiting example, the student neural network 302(j−1) can have any suitable trainable biases, and the trained internal parameter value array 806 can indicate or specify numerical values that were respectively assigned to those trainable biases at the termination of training of the student neural network 302(j−1). As yet another non-limiting example, the student neural network 302(j−1) can have any suitable trainable convolutional kernels, and the trained internal parameter value array 806 can indicate or specify numerical values that were respectively assigned to those trainable convolutional kernels at the termination of training of the student neural network 302(j−1). As still another non-limiting example, the student neural network 302(j−1) can have any suitable trainable scaling factors or shifting factors, and the trained internal parameter value array 806 can indicate or specify numerical values that were respectively assigned to those trainable scaling factors or shifting factors at the termination of training of the student neural network 302(j−1).

Just as above, in some cases, the trained internal parameter value array 806 can be considered as indicating or otherwise specifying whatever values all of the trainable internal parameters of the student neural network 302(j−1) have. In other cases, the trained internal parameter value array 806 can be considered as indicating or otherwise specifying whatever values fewer than all of the trainable internal parameters of the student neural network 302(j−1) have (e.g., can specify the values of only those trainable internal parameters that are in one or more particular layers of the student neural network 302(j−1)).

In various aspects, the current internal parameter value array 802 and the trained internal parameter value array 806 can have the same format, size, or dimensionality as each other. Thus, in various instances, the distillation component 114 can compute the similarity score 702(j−1) by applying a cosine similarity function to the current internal parameter value array 802 and to the trained internal parameter value array 806. Indeed, just as above, the current internal parameter value array 802 and the trained internal parameter value array 806 can both be considered as high-dimensional vectors, and the similarity score 702(j−1) can be equal to or otherwise based on a cosine similarity between such high-dimensional vectors. In such case, higher values (e.g., closer to 1) of the similarity score 702(j−1) can be considered as indicating a higher degree of similarity, and thus a higher degree of redundancy, between the trainable internal parameters of the student neural network 302(j) and those of the student neural network 302(j−1). In contrast, lower values (e.g., closer to 0) of the similarity score 702(j−1) can be considered as indicating a lower degree of similarity, and thus a lower degree of redundancy, between the trainable internal parameters of the student neural network 302(j) and those of the student neural network 302(j−1).

FIGS. 9-10 illustrate example, non-limiting block diagrams 900 and 1000 showing how the similarity error term 410 of the retrospective loss function 304 can be obtained in a feature-space of the student neural network 302(j) in accordance with one or more embodiments described herein.

First, consider FIG. 9. In various embodiments, as mentioned above, the distillation component 114 can execute the student neural network 302(j) on the training data candidate 502, which can cause the student neural network 302(j) to produce the output 506. In various aspects, during such execution, the student neural network 302(j) can compute as intermediate outputs one or more hidden activation maps 902, where the one or more hidden activation maps 902 can include any suitable number of hidden activation maps, and where a hidden activation map can be one or more scalars, one or more vectors, one or more matrices, or one or more tensors generated by any hidden layer of the student neural network 302(j). More specifically, the distillation component 114 can feed the training data candidate 502 to the input layer of the student neural network 302(j), the training data candidate 502 can complete a forward pass through whatever hidden layers the student neural network 302(j) possesses, one or more of those hidden layers can produce the one or more hidden activation maps 902, and the output layer of the student neural network 302(j) can compute the output 506 based on the one or more hidden activation maps 902 and based on any other activation maps generated by the hidden layers of the student neural network 302(j).

Similarly, in various aspects, the distillation component 114 can execute the student neural network 302(1) on the training data candidate 502, which can cause the student neural network 302(1) to produce an output 904, where the output 904 can be considered as a predicted inferencing task result that the student neural network 302(1) has determined corresponds to the training data candidate 502. In various aspects, during such execution, the student neural network 302(1) can compute as intermediate outputs one or more hidden activation maps 906 that have the same format, size, or dimensionality as the one or more hidden activation maps 902. More specifically, the distillation component 114 can feed the training data candidate 502 to an input layer of the student neural network 302(1), the training data candidate 502 can complete a forward pass through whatever hidden layers the student neural network 302(1) possesses, one or more of those hidden layers can produce the one or more hidden activation maps 906, and an output layer of the student neural network 302(1) can compute the output 904 based on the one or more hidden activation maps 906 and based on any other activation maps generated by the hidden layers of the student neural network 302(1).

In various instances, the distillation component 114 can compute the similarity score 702(1) by applying a reciprocal of a Euclidean distance function to the one or more hidden activation maps 902 and to the one or more hidden activation maps 906. In other words, the one or more hidden activation maps 902 and the one or more hidden activation maps 906 can both be considered as high-dimensional vectors, and the similarity score 702(1) can be equal to or otherwise based on a reciprocal of a Euclidean distance between such high-dimensional vectors. In such case, higher values of the similarity score 702(1) (e.g., lower values of the Euclidean distance between such vectors) can be considered as indicating a higher degree of similarity, and thus a higher degree of redundancy, between the student neural network 302(j) and the student neural network 302(1). In contrast, lower values of the similarity score 702(1) (e.g., higher values of the Euclidean distance between such vectors) can be considered as indicating a lower degree of similarity, and thus a lower degree of redundancy, between the student neural network 302(j) and the student neural network 302(1).

Now, consider FIG. 10. As explained above, the distillation component 114 can execute the student neural network 302(j) on the training data candidate 502, which can cause the student neural network 302(j) to produce the one or more hidden activation maps 902.

Likewise, in various aspects, the distillation component 114 can execute the student neural network 302(j−1) on the training data candidate 502, which can cause the student neural network 302(j−1) to produce an output 1002, where the output 1002 can be considered as a predicted inferencing task result that the student neural network 302(j−1) has determined corresponds to the training data candidate 502. In various aspects, during such execution, the student neural network 302(j−1) can compute as intermediate outputs one or more hidden activation maps 1004 that have the same format, size, or dimensionality as the one or more hidden activation maps 902. More specifically, the distillation component 114 can feed the training data candidate 502 to an input layer of the student neural network 302(j−1), the training data candidate 502 can complete a forward pass through whatever hidden layers the student neural network 302(j−1) possesses, one or more of those hidden layers can produce the one or more hidden activation maps 1004, and an output layer of the student neural network 302(j−1) can compute the output 1002 based on the one or more hidden activation maps 1004 and based on any other activation maps generated by the hidden layers of the student neural network 302(j−1).

In various instances, the distillation component 114 can compute the similarity score 702(j−1) by applying a reciprocal of a Euclidean distance function to the one or more hidden activation maps 902 and to the one or more hidden activation maps 1004. In other words, and just as above, the one or more hidden activation maps 902 and the one or more hidden activation maps 1004 can both be considered as high-dimensional vectors, and the similarity score 702(j−1) can be equal to or otherwise based on a reciprocal of a Euclidean distance between such high-dimensional vectors. In such case, higher values of the similarity score 702(j−1) (e.g., lower values of the Euclidean distance between such vectors) can be considered as indicating a higher degree of similarity, and thus a higher degree of redundancy, between the student neural network 302(j) and the student neural network 302(j−1). In contrast, lower values of the similarity score 702(j−1) (e.g., higher values of the Euclidean distance between such vectors) can be considered as indicating a lower degree of similarity, and thus a lower degree of redundancy, between the student neural network 302(j) and the student neural network 302(j−1).

Using mathematical notation, the similarity error term 410 during the j-th knowledge distillation iteration can, in a non-limiting embodiment, be represented as follows:

$$β * {\sum }_{l = 1}^{j - 1} {L}_{cosine} ( {ϕ}_{j} , {ϕ}_{l} )$$

where β can be any suitable hyperparameter, where ϕⱼ can be the current internal parameter value array 802, where ϕ₁ can be the trained internal parameter value array of the l-th student neural network, and where L_{cosine} can denote a cosine similarity function.

In various aspects, the distillation component 114 can compute the ground-truth error term 406, the distillation error term 408, and the similarity error term 410 as described with respect to FIGS. 5-10 during the j-th knowledge distillation iteration, and the distillation component 114 can then compute the retrospective loss function 304 based on the ground-truth error term 406, the distillation error term 408, and the similarity error term 410 (e.g., by summing the ground-truth error term 406, the distillation error term 408, and the similarity error term 410 together).

In various instances, the distillation component 114 can incrementally update, via backpropagation (e.g., stochastic gradient descent), the trainable internal parameters (e.g., the weight matrices, the biases, the convolutional kernels) of the student neural network 302(j), where such backpropagation can be driven by the retrospective loss function 304.

In various aspects, the distillation component 114 can repeat this training procedure (e.g., selecting a training data candidate from the training dataset 106, computing the retrospective loss function 304 for that new training data candidate, and updating the trainable internal parameters of the student neural network 302(j) based on the retrospective loss function 304) for any suitable number of training iterations (e.g., until any suitable training termination criterion is achieved with respect to the student neural network 302(j)). Note that all of such training iterations of the student neural network 302(j) can be considered as occurring during or within the j-th knowledge distillation iteration. Furthermore, note that, although such training procedure has mainly been described with respect to a training batch size of one, this is a mere non-limiting example for ease of illustration and explanation. In various cases, the distillation component 114 can utilize any suitable training batch sizes when training the student neural network 302(j) during the j-th knowledge distillation iteration.

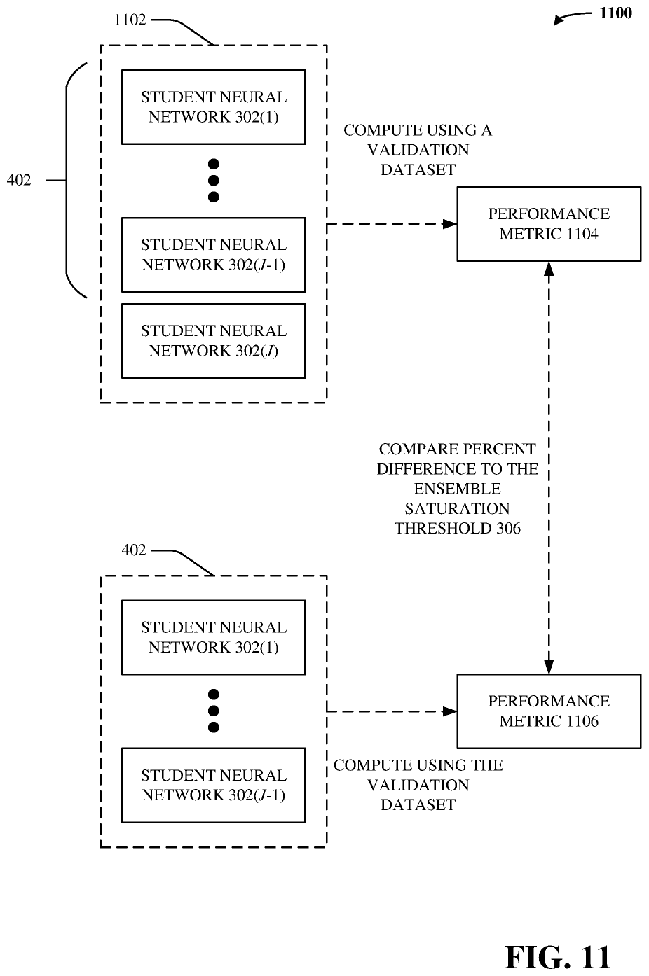

In various aspects, once the student neural network 302(j) has completed training, the distillation component 114 can determine whether or not a (j+1)-th knowledge distillation iteration should be commenced (e.g., whether or not a (j+1)-th student neural network should be added to the condensed deep learning ensemble 302). In various instances, the distillation component 114 can facilitate this determination by utilizing the ensemble saturation threshold 306, as described with respect to FIG. 11.

FIG. 11 illustrates an example, non-limiting block diagram 1100 showing how the ensemble saturation threshold 306 can be used to determine whether the condensed deep learning ensemble 302 is complete in accordance with one or more embodiments described herein.

In various aspects, during the j-th knowledge distillation iteration and after the student neural network 302(j) has been trained by the distillation component 114, the condensed deep learning ensemble 302 can have a total of j trained student neural networks (e.g., the student neural network 302(j) and the condensed ensemble subset 402). For ease of illustration and explanation, such j trained student neural networks can be collectively referred to as a condensed ensemble subset 1102. However, before the j-th knowledge distillation iteration, the condensed deep learning ensemble 302 can instead have had a total of (j−1) trained student neural networks. In other words, at the conclusion of the (j−1)-th knowledge distillation iteration, the condensed deep learning ensemble 302 can have comprised only the condensed ensemble subset 402 and can have lacked the student neural network 302(j).

Now, in various aspects, the distillation component 114 can compute a performance metric 1104 for the condensed ensemble subset 1102. Indeed, in various instances, the distillation component 114 can execute the condensed ensemble subset 1102 on any suitable validation dataset (not shown), and the performance metric 1104 can be any suitable scalar that indicates a performance-related attribute or performance-related characteristic achieved by the condensed ensemble subset 1102 with respect to that validation dataset. As a non-limiting example, the performance metric 1104 can be a test accuracy percentage achieved by the condensed ensemble subset 1102 with respect to that validation dataset.

Likewise, in various aspects, the distillation component 114 can compute a performance metric 1106 for the condensed ensemble subset 402. Just as above, in various instances, the distillation component 114 can execute the condensed ensemble subset 402 on the validation dataset, and the performance metric 1106 can be any suitable scalar that indicates a performance-related attribute or performance-related characteristic achieved by the condensed ensemble subset 402 with respect to the validation dataset. As a non-limiting example, the performance metric 1106 can be a test accuracy percentage achieved by the condensed ensemble subset 402 with respect to the validation dataset. Note that, in some cases, the distillation component 114 can have computed the performance metric 1106 during the (j−1)-th knowledge distillation iteration. In such case, the distillation component 114 can refrain from redundantly recomputing the performance metric 1106 during the j-th knowledge distillation iteration.

In any case, the performance metric 1106 can be considered as indicating or representing how well the condensed deep learning ensemble 302 performed before addition of the student neural network 302(j), whereas the performance metric 1104 can be considered as indicating or representing how well the condensed deep learning ensemble 302 performed after addition of the student neural network 302(j). In various instances, the distillation component 114 can compute an absolute or percentage difference between the performance metric 1104 and the performance metric 1106.

In various aspects, the ensemble saturation threshold 306 can be any suitable scalar value. In various instances, the distillation component 114 can compare the computed absolute or percentage difference to the ensemble saturation threshold 306. If the computed absolute or percentage difference is greater than (or equal to) the ensemble saturation threshold 306, then the distillation component 114 can proceed to a (j+1)-th knowledge distillation iteration. In other words, the distillation component 114 can determine that the condensed deep learning ensemble 302 benefitted so much from insertion of the student neural network 302(j) such that insertion of a (j+1)-th student neural network is warranted. In contrast, if the computed absolute or percentage difference is less than (or equal to) the ensemble saturation threshold 306, then the distillation component 114 can refrain from proceeding to a (j+1)-th knowledge distillation iteration. That is, the distillation component 114 can determine that the condensed deep learning ensemble 302 benefitted so little from insertion of the student neural network 302(j), such that insertion of a (j+1)-th student neural network is not warranted. In such case, generation or construction of the condensed deep learning ensemble 302 can be considered as being complete or finished.

As mentioned above, FIGS. 5-11 illustrate how the distillation component 114 can perform a j-th knowledge distillation iteration, for any suitable positive integer j≤m.

As described herein, the m-th knowledge distillation iteration (e.g., when j=m) can be considered as the final knowledge distillation iteration. However, note that m can be not fixed, not pre-defined, and otherwise not pre-set a priori. That is, m can be not known ahead of time. Instead, m can be a variable that depends upon the retrospective loss function 304 and the ensemble saturation threshold 306. In other words, the value of m can be equal to whatever value j has when the distillation component 114 determines that the ensemble saturation threshold 306 has been satisfied (e.g., when the distillation component 114 determines that the condensed deep learning ensemble 302 is complete or finished).

Moreover, note that, when j=1, the condensed ensemble subset 402 can be empty (e.g., during the very first knowledge distillation iteration, there can be no previously-added student neural networks in the condensed deep learning ensemble 302). In such case, the distillation component 114 can refrain from computing the similarity error term 410. Additionally, in such case, the distillation component 114 can proceed to the second knowledge distillation iteration without first checking the performance of the condensed ensemble subset 1102 against the ensemble saturation threshold 306.

In any case, the distillation component 114 can distill the deep learning ensemble 104 into the condensed deep learning ensemble 302, by leveraging the training dataset 106, the retrospective loss function 304, and the ensemble saturation threshold 306.

In various embodiments, the execution component 116 can electronically deploy the condensed deep learning ensemble 302 in any suitable operational or clinical context. More specifically, when given any specific data candidate for which a ground-truth annotation is unavailable (e.g., a medical X-ray scanned image of a real-world medical patient for which a predicted segmentation mask is desired, a medical MRI scanned image of a real-world medical patient for which a predicted classification label is desired, a medical ultrasound scanned image of a real-world medical patient for which a predicted regression output is desired), the execution component 116 can execute the condensed deep learning ensemble 302 on that specific data candidate, which can cause the condensed deep learning ensemble 302 to produce an aggregated output for that specific data candidate. More specifically, the execution component 116 can execute each of the m student neural networks that make up the condensed deep learning ensemble 302 on that specific data candidate, thereby yielding a total of m individual outputs.

As a non-limiting example, the execution component 116 can feed the specific data candidate to an input layer of the student neural network 302(1), the specific data candidate can complete a forward pass through one or more hidden layers of the student neural network 302(1), and an output layer of the student neural network 302(1) can compute a first individual output based on activation maps generated by the one or more hidden layers of the student neural network 302(1). Such first individual output can be considered as a first predicted inferencing task result (e.g., a first predicted classification label, a first predicted segmentation mask, a first predicted regression output) that the student neural network 302(1) has determined corresponds to the specific data candidate.

As another non-limiting example, the execution component 116 can feed the specific data candidate to an input layer of the student neural network 302(m), the specific data candidate can complete a forward pass through one or more hidden layers of the student neural network 302(m), and an output layer of the student neural network 302(m) can compute an m-th individual output based on activation maps generated by the one or more hidden layers of the student neural network 302(m). Such m-th individual output can be considered as an m-th predicted inferencing task result (e.g., an m-th predicted classification label, an m-th predicted segmentation mask, an m-th predicted regression output) that the student neural network 302(m) has determined corresponds to the specific data candidate.

In various aspects, the aggregated output produced by the condensed deep learning ensemble 302 can be equal to or otherwise based on a combination (e.g., a weighted or non-weighted average) of such m individual outputs. Accordingly, the aggregated output can be considered as an averaged or overall inferencing task result (e.g., averaged or overall classification label, averaged or overall segmentation mask, averaged or overall regression output) that the condensed deep learning ensemble 302 has collectively determined should correspond to the specific data candidate.

Note that implementation of the retrospective loss function 304 and of the ensemble saturation threshold 306 as described herein can cause the condensed deep learning ensemble 302 to have a minimized or approximately minimized computational footprint while also achieving comparable inferencing accuracy as the deep learning ensemble 104. Indeed, the ground-truth error term 406 of the retrospective loss function 304 can be considered as causing each student neural network to learn how to accurately perform the inferencing task. Moreover, the distillation error term 408 of the retrospective loss function 304 can be considered as causing each student neural network to learn how to emulate the collective inferencing behavior of the deep learning ensemble 104. Furthermore, the ensemble saturation threshold 306 can be considered as delineating when “enough” student neural networks have been inserted into the condensed deep learning ensemble 302. Further still, the similarity error term 410 of the retrospective loss function 304 can be considered as causing each student neural network to be dissimilar to, and thus non-redundant with, each previously-inserted student neural network, such that whatever number of student neural networks is “enough” for the condensed deep learning ensemble 302 is as small as practicable (e.g., is minimized or approximately minimized).

Indeed, the present inventors experimentally verified such technical benefits. In particular, the present inventors conducted an experiment. During such experiment, a single teacher neural network having a Resnet-18 architecture was trained to perform an inferencing task on inputted data candidates. That single teacher neural network achieved a test loss of 1.6480 and a test accuracy of 0.8120. Because the single teacher neural network was not an ensemble, an expected calibration error could not be computed.

Also, during such experiment, a baseline deep ensemble was trained to perform the inferencing task on inputted data candidates, where the baseline deep ensemble comprised ten teacher neural networks, each having a Resnet-18 architecture. That baseline deep ensemble achieved a test loss of 1.6439, a test accuracy of 0.8332, and an expected calibration error 6.13. In other words, the baseline deep ensemble outperformed the single teacher neural network.

Additionally, during such experiment, a first condensed ensemble was trained as described herein to perform the inferencing task on inputted data candidates, where the first condensed ensemble comprised only two student neural networks, each having a Resnet-18 architecture. During such training, the similarity error term 410 was computed in parameter-space using cosine similarity, and the internal parameter value arrays that were utilized indicated or specified only the trainable weights of the fully-connected layer of each student neural network (e.g., dissimilarity/non-redundancy was enforced only for the fully-connected layers). Such first condensed deep ensemble achieved a test loss of 1.6162, a test accuracy of 0.8472, and an expected calibration error of 3.25. That is, the first deep ensemble outperformed the baseline deep ensemble, while having merely one-fifth of the computational footprint of the baseline deep ensemble.

Furthermore, during such experiment, a second condensed ensemble was trained as described herein to perform the inferencing task on inputted data candidates, where the second condensed ensemble comprised only two student neural networks, each having a Resnet-18 architecture. During such training, the similarity error term 410 was computed in parameter-space using cosine similarity, and the internal parameter value arrays that were utilized indicated or specified only the trainable weights of the fully-connected layer of each student neural network and the trainable layer-4 convolutional kernels of each student neural network (e.g., dissimilarity/non-redundancy was enforced only for the fully-connected layers and the layer-4 convolutional kernels). Such second condensed deep ensemble achieved a test loss of 1.6142, a test accuracy of 0.8481, and an expected calibration error of 3.22. That is, the second deep ensemble also outperformed the baseline deep ensemble, while having merely one-fifth of the computational footprint of the baseline deep ensemble.

Further still, during such experiment, a third condensed ensemble was trained as described herein to perform the inferencing task on inputted data candidates, where the third condensed ensemble comprised only two student neural networks, each having a Resnet-18 architecture. During such training, the similarity error term 410 was computed in parameter-space using cosine similarity, and the internal parameter value arrays that were utilized indicated or specified only the trainable weights of the fully-connected layer of each student neural network, the trainable layer-4 convolutional kernels of each student neural network, and the trainable layer-3 convolutional kernels of each student neural network (e.g., dissimilarity/non-redundancy was enforced only for the fully-connected layers, the layer-4 convolutional kernels, and the layer-3 convolutional kernels). Such third condensed deep ensemble achieved a test loss of 1.6163, a test accuracy of 0.8468, and an expected calibration error of 3.29. Thus, the third deep ensemble also outperformed the baseline deep ensemble, while having merely one-fifth of the computational footprint of the baseline deep ensemble.

Note that, in various aspects, the condensed deep learning ensemble 302 can be considered as a comparably-accurate, more-computationally-efficient replacement or substitute for the deep learning ensemble 104. As a non-limiting example, suppose that the deep learning ensemble 104 is a stand-alone ensemble for use in a particular operational context (e.g. in a clinical or medical setting, such as in a hospital). In such case, the condensed deep learning ensemble 302 can replace the deep learning ensemble 104 and thus can likewise be considered as a stand-alone ensemble for use in that particular operational context. As another non-limiting example, suppose that the deep learning ensemble 104 is an ensemble of head networks positioned serially downstream of a common backbone neural network (e.g., each teacher neural network of the deep learning ensemble 104 can be configured to receive as input whatever data is outputted by the common backbone neural network). In such case, the condensed deep learning ensemble 302 can replace the deep learning ensemble 104 and thus can likewise be considered as an ensemble of head networks (e.g., having fewer heads) positioned serially downstream of that common backbone neural network (e.g., each student neural network of the condensed deep learning ensemble 302 can be configured to receive as input whatever data is outputted by the common backbone neural network).

Indeed, in some embodiments, a common backbone network can be serially upstream from multiple groups of head networks, where the multiple groups of head networks can be in parallel with each other, and where each group of head networks can be considered as a distinct deep learning ensemble that is configured to perform a respective inferencing task (e.g., a first group of head networks that are serially downstream from the common backbone network can be a classification ensemble, a second group of head networks that are serially downstream from the common backbone network can be a segmentation ensemble, a third group of head networks that are serially downstream from the common backbone network can be a regression ensemble). Such embodiments can be considered as involving a multi-task backbone-head pipeline. In such embodiments, various teachings described herein can be implemented to distill any given group of head networks into a condensed group of head networks having a reduced computational footprint without deteriorated prediction accuracy. In some instances, such distillation can be performed on all of the groups of head networks that are serially downstream of the common backbone network. In other instances, such distillation can be performed on fewer than all of the groups of head networks that are serially downstream of the common backbone network.

As mentioned above, the deep learning ensemble 104 can, in some embodiments, be hosted on a medical scanning device (e.g., a CT scanner, an MRI scanner, a PET scanner, an X-ray scanner, an ultrasound scanner). As also mentioned above, the condensed deep learning ensemble 302 can be considered as a comparably-accurate yet more computationally-efficient replacement or substitute for the deep learning ensemble 104. Accordingly, the execution component 116 can, in various aspects, remove or delete the deep learning ensemble 104 from the medical scanning device and can install or deploy the condensed deep learning ensemble 302 onto the medical scanning device. In such case, the medical scanning device can be considered as now hosting the condensed deep learning ensemble 302 instead of the deep learning ensemble 104. In various instances, this can allow the medical scanning device to perform the inferencing task with comparable (or even better) accuracy on whatever medical scanned images it captures or generates, while simultaneously consuming fewer computational resources (e.g., less memory space, less processing capacity, less inferencing time).

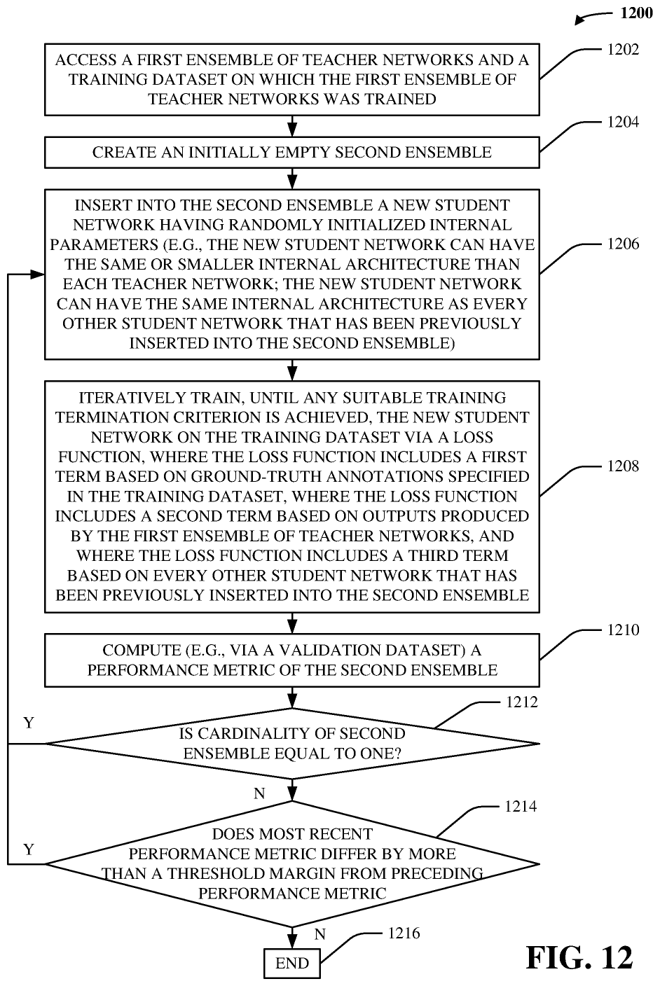

FIG. 12 illustrates a flow diagram of an example, non-limiting computer-implemented method 1200 that can facilitate improved distillation of deep ensembles in accordance with one or more embodiments described herein. In various cases, the deep ensemble distillation system 102 can facilitate the computer-implemented method 1200.

In various embodiments, act 1202 can include accessing, by a device (e.g., via 112) operatively coupled to a processor (e.g., 108), a first ensemble (e.g., 104) of teacher networks and a training dataset (e.g., 106) on which the first ensemble of teacher networks was trained.

In various aspects, act 1204 can include creating, by the device (e.g., via 114), an initially empty second ensemble (e.g., 302).

In various instances, act 1206 can include inserting, by the device (e.g., via 114), into the second ensemble a new student network (e.g., 302(j)) having randomly initialized internal parameters. In various cases, the new student network can have the same or smaller internal architecture (e.g., the same or fewer number or arrangement of layers, the same or fewer number or arrangement of trainable internal parameters) than each teacher network. Moreover, in various cases, the new student network can have the same internal architecture (e.g., the same number and arrangement of layers, the same number and arrangement of trainable internal parameters) as every other student network that has been previously inserted into the second ensemble.

In various aspects, act 1208 can include iteratively training, by the device (e.g., via 114) and until any suitable training termination criterion is achieved, the new student network on the training dataset via a loss function (e.g., 304). In various instances, the loss function can include a first term (e.g., 406) that can be based on ground-truth annotations (e.g., 504) specified in the training dataset. In various cases, the loss function can include a second term (e.g., 408) that can be based on outputs (e.g., 602) produced by the first ensemble of teacher networks. In various aspects, the loss function can include a third term (e.g., 410) that can be based on every other student network (e.g., 402) that has been previously inserted into the second ensemble.

In various instances, act 1210 can include computing, by the device (e.g., via 114) a performance metric (e.g., 1104) of the second ensemble. In some cases, such computation can be facilitated by executing the second ensemble as currently constituted on a validation dataset.

In various aspects, act 1212 can include determining, by the device (e.g., via 114), whether a cardinality of (e.g., whether the number of student networks within) the second ensemble is equal to one. If so (e.g., if the current knowledge distillation iteration is the first knowledge distillation iteration), the computer-implemented method 1200 can proceed back to act 1206. If not (e.g., if the current knowledge distillation iteration is later than the first knowledge distillation iteration), the computer-implemented method 1200 can instead proceed to act 1214.

In various instances, act 1214 can include determining, by the device (e.g., via 114), whether the most recent performance metric (e.g., 1104) differs by more than a threshold margin (e.g., 306) from a preceding performance metric (e.g., 1106). If so, the computer-implemented method 1200 can proceed back to act 1206 (e.g., it can be determined that insertion of another student network is warranted). If not, the computer-implemented method 1200 can instead end at act 1216 (e.g., it can be determined that insertion of another student network is not warranted).

Note that each pass through acts 1206-1212 or 1206-1214 can be considered as a single knowledge distillation iteration.

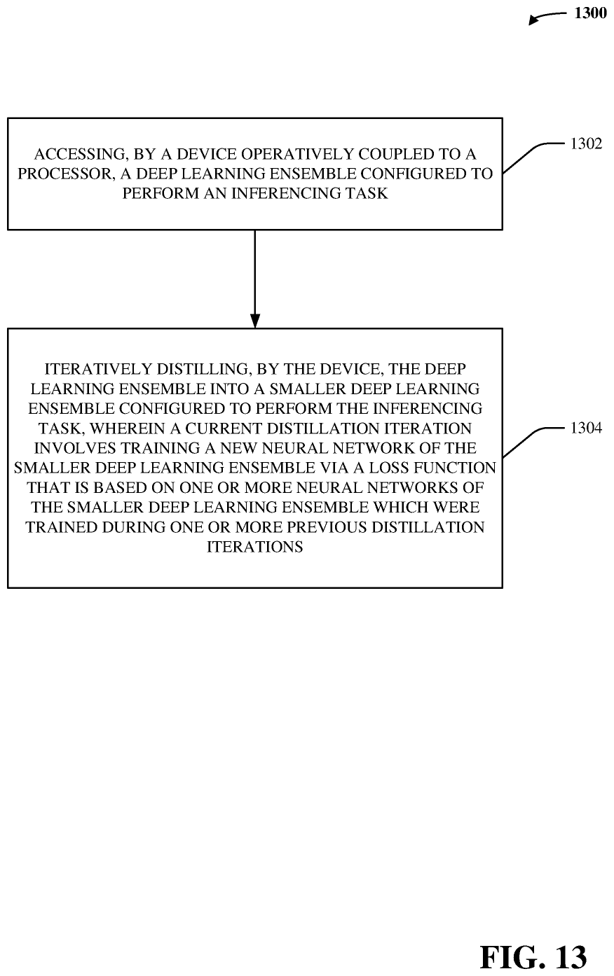

FIG. 13 illustrates a flow diagram of an example, non-limiting computer-implemented method 1300 that can facilitate improved distillation of deep ensembles in accordance with one or more embodiments described herein. In various cases, the deep ensemble distillation system 102 can facilitate the computer-implemented method 1300.

In various embodiments, act 1302 can include accessing, by a device (e.g., via 112) operatively coupled to a processor (e.g., 108), a deep learning ensemble (e.g., 104) configured to perform an inferencing task.

In various aspects, act 1304 can include iteratively distilling, by the device (e.g., via 114), the deep learning ensemble into a smaller deep learning ensemble (e.g., 302) configured to perform the inferencing task. In various cases, a current distillation iteration (e.g., the j-th knowledge distillation iteration) can involve training a new neural network (e.g., 302(j)) of the smaller deep learning ensemble via a loss function (e.g., 304) that is based on one or more neural networks (e.g., 402) of the smaller deep learning ensemble which were trained during one or more previous distillation iterations.

Although not explicitly shown in FIG. 13, the computer-implemented method 1300 can comprise: accessing, by the device (e.g., via 112), a training dataset (e.g., 106). In various aspects, the current distillation iteration can comprise: initializing, by the device (e.g., via 114), trainable internal parameters (e.g., weight matrices, biases, convolutional kernels) of the new neural network; selecting, by the device (e.g., via 114) and from the training dataset, one or more training data candidates (e.g., 502) and one or more ground-truth annotations (e.g., 504) corresponding to the one or more training data candidates; executing, by the device (e.g., via 114), the new neural network on the one or more training data candidates, thereby yielding one or more first inferencing task outputs (e.g., 506); executing, by the device (e.g., via 114), the deep learning ensemble on the one or more training data candidates, thereby yielding one or more second inferencing task outputs (e.g., 602); updating, by the device (e.g., via 114) and via backpropagation, the trainable internal parameters of the new neural network based on the loss function, wherein the loss function can include a first term (e.g., 406) that quantifies errors between the one or more first inferencing task outputs and the one or more ground-truth annotations, wherein the loss function can include a second term (e.g., 408) that quantifies errors between the one or more first inferencing task outputs and the one or more second inferencing task outputs, and wherein the loss function can include a third term (e.g., 410) that quantifies similarities between the new neural network and the one or more neural networks of the smaller deep learning ensemble which were trained during the one or more previous distillation iterations; and repeating, by the device (e.g., via 114), respective above acts until a training termination criterion associated with the new neural network is satisfied.

In various aspects, the third term of the loss function can be based on cosine similarities between: the trainable internal parameters (e.g., 802) of the new neural network; and trainable internal parameters (e.g., 804, 806) of the one or more neural networks of the smaller deep learning ensemble which were trained during the one or more previous distillation iterations (e.g., as shown with respect to FIG. 8).

In various instances, the third term of the loss function can be based on reciprocals of distances between: hidden feature maps (e.g., 902) produced by the new neural network; and hidden feature maps (e.g., 906, 1004) produced by the one or more neural networks of the smaller deep learning ensemble which were trained during the one or more previous distillation iterations (e.g., as shown with respect to FIGS. 9-10).

Although not explicitly shown in FIG. 13, the current distillation iteration can further comprise: computing, by the device (e.g., via 114) and in response to the training termination criterion being satisfied by the new neural network, a current performance metric (e.g., 1104) of the smaller deep learning ensemble; comparing, by the device (e.g., via 114), the current performance metric to a previous performance metric (e.g., 1106) of the smaller deep learning ensemble that was computed during a previous distillation iteration; commencing, by the device (e.g., via 114), a next distillation iteration (e.g., (j+1)-th knowledge distillation iteration), in response to the current performance metric differing from the previous performance metric by more than a threshold margin (e.g., 306); and determining, by the device (e.g., via 114), that the smaller deep learning ensemble is complete, in response to the current performance metric differing from the previous performance metric by less than the threshold margin.

Although not explicitly shown in FIG. 13, the computer-implemented method 1300 can comprise: deploying, by the device (e.g., via 116), the smaller deep learning ensemble, in response to a determination that the smaller deep learning ensemble is complete.

Various embodiments described herein can include a computer program product for facilitating improved distillation of deep ensembles. In various aspects, the computer program product can comprise a non-transitory computer-readable memory (e.g., 110) having program instructions embodied therewith. In various instances, the program instructions can be executable by a processor (e.g., 108) to cause the processor to: access an ensemble of teacher networks (e.g., 104) hosted on a medical scanning device (e.g., an X-ray scanner, an MRI scanner, a PET scanner, an ultrasound scanner, a CT scanner) and a training dataset (e.g., 106) on which the ensemble of teacher networks was trained; iteratively train a condensed ensemble of student networks (e.g., 302) based on the ensemble of teacher networks and based on the training dataset, wherein each new student network (e.g., 302(j)) of the condensed ensemble can be trained via a loss (e.g., 304) that is based on all previously-trained student networks (e.g., 402) in the condensed ensemble; and replace the ensemble of teacher networks on the medical scanning device with the condensed ensemble of student networks.

In various aspects, the program instructions can be further executable to cause the processor to: cease iteratively training the condensed ensemble when a current performance metric (e.g., 1104) of the condensed ensemble is within a threshold margin (e.g., 306) of a previous performance metric (e.g., 1106) of the condensed ensemble.

In various instances, for each of the previously-trained student networks, the loss can include a cosine similarity computed between trainable internal parameters (e.g., 804, 806) of that previously-trained student network and trainable internal parameters (e.g., 802) of the new student network.

In various cases, for each of the previously-trained student networks, the loss can include a distance computed between hidden activation maps (e.g., 906, 1004) of that previously-trained student network and hidden activation maps (e.g., 902) of the new student network.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

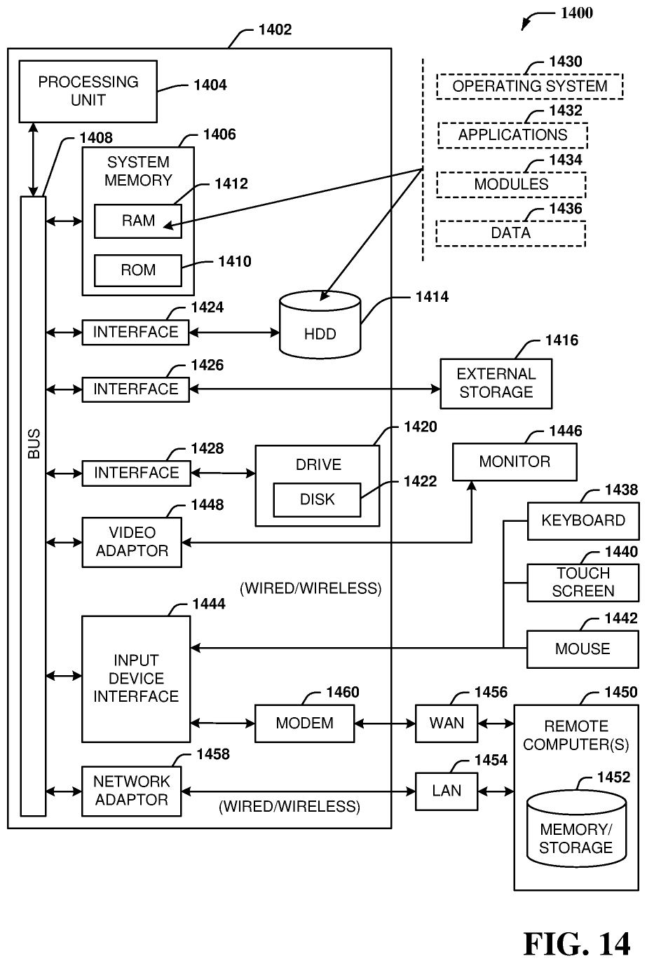

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and a drive 1420, e.g., such as a solid state drive, an optical disk drive, which can read or write from a disk 1422, such as a CD-ROM disc, a DVD, a BD, etc. Alternatively, where a solid state drive is involved, disk 1422 would not be included, unless separate. While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and drive 1420 can be connected to the system bus 1408 by an HDD interface 1424, an external storage interface 1426 and a drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above, such as but not limited to a network virtual machine providing one or more aspects of storage or processing of information. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

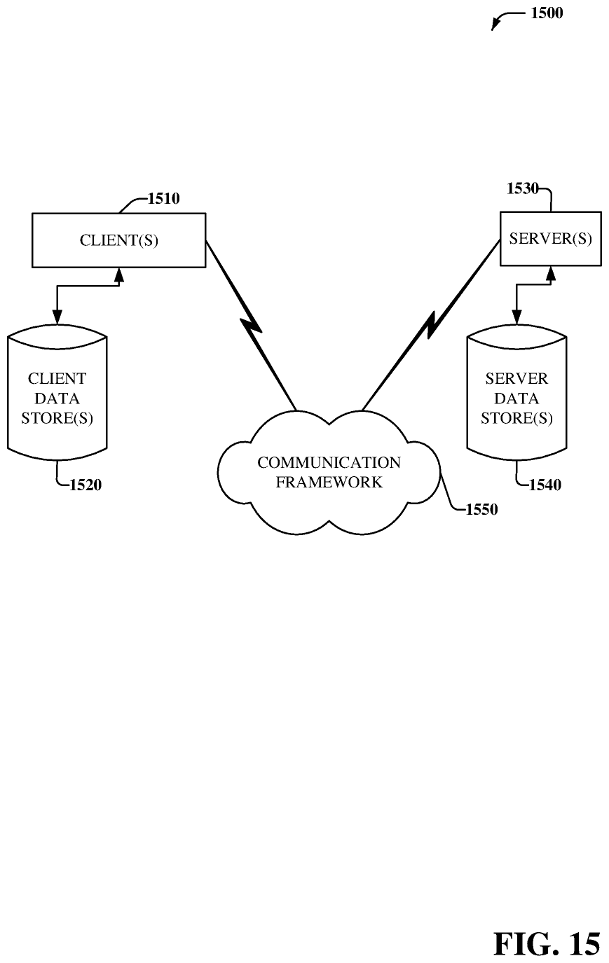

FIG. 15 is a schematic block diagram of a sample computing environment 1500 with which the disclosed subject matter can interact. The sample computing environment 1500 includes one or more client(s) 1510. The client(s) 1510 can be hardware or software (e.g., threads, processes, computing devices). The sample computing environment 1500 also includes one or more server(s) 1530. The server(s) 1530 can also be hardware or software (e.g., threads, processes, computing devices). The servers 1530 can house threads to perform transformations by employing one or more embodiments as described herein, for example. One possible communication between a client 1510 and a server 1530 can be in the form of a data packet adapted to be transmitted between two or more computer processes. The sample computing environment 1500 includes a communication framework 1550 that can be employed to facilitate communications between the client(s) 1510 and the server(s) 1530. The client(s) 1510 are operably connected to one or more client data store(s) 1520 that can be employed to store information local to the client(s) 1510. Similarly, the server(s) 1530 are operably connected to one or more server data store(s) 1540 that can be employed to store information local to the servers 1530.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, the computer-executable components comprising:
an access component that accesses a deep learning ensemble configured to perform an inferencing task; and
a distillation component that iteratively distills the deep learning ensemble into a smaller deep learning ensemble configured to perform the inferencing task, wherein a current distillation iteration involves training a new neural network of the smaller deep learning ensemble via a loss function that is based on one or more neural networks of the smaller deep learning ensemble which were trained during one or more previous distillation iterations.

2. The system of claim 1, wherein the access component accesses a training dataset, and wherein, during the current distillation iteration, the distillation component:
initializes trainable internal parameters of the new neural network;
selects, from the training dataset, one or more training data candidates and one or more ground-truth annotations corresponding to the one or more training data candidates;
executes the new neural network on the one or more training data candidates, thereby yielding one or more first inferencing task outputs;
executes the deep learning ensemble on the one or more training data candidates, thereby yielding one or more second inferencing task outputs;
updates, via backpropagation, the trainable internal parameters of the new neural network based on the loss function, wherein the loss function includes a first term that quantifies errors between the one or more first inferencing task outputs and the one or more ground-truth annotations, wherein the loss function includes a second term that quantifies errors between the one or more first inferencing task outputs and the one or more second inferencing task outputs, and wherein the loss function includes a third term that quantifies similarities between the new neural network and the one or more neural networks of the smaller deep learning ensemble which were trained during the one or more previous distillation iterations; and
repeats respective above acts until a training termination criterion associated with the new neural network is satisfied.

3. The system of claim 2, wherein the third term of the loss function is based on cosine similarities between:
the trainable internal parameters of the new neural network; and
trainable internal parameters of the one or more neural networks of the smaller deep learning ensemble which were trained during the one or more previous distillation iterations.

4. The system of claim 2, wherein the third term of the loss function is based on reciprocals of distances between:
hidden feature maps produced by the new neural network; and
hidden feature maps produced by the one or more neural networks of the smaller deep learning ensemble which were trained during the one or more previous distillation iterations.

5. The system of claim 2, wherein, during the current distillation iteration, the distillation component:
in response to the training termination criterion being satisfied by the new neural network, computes a current performance metric of the smaller deep learning ensemble;
compares the current performance metric to a previous performance metric of the smaller deep learning ensemble that was computed during a previous distillation iteration;
commences a next distillation iteration, in response to the current performance metric differing from the previous performance metric by more than a threshold margin; and
determines that the smaller deep learning ensemble is complete, in response to the current performance metric differing from the previous performance metric by less than the threshold margin.

6. The system of claim 5, wherein the computer-executable components comprise:
an execution component that deploys the smaller deep learning ensemble, in response to the distillation component determining that the smaller deep learning ensemble is complete.

7. The system of claim 1, wherein each neural network of the smaller deep learning ensemble exhibits a smaller footprint than each neural network of the deep learning ensemble.

8. The system of claim 1, wherein the deep learning ensemble serves as a group of network heads for a common backbone network, and wherein the smaller deep learning ensemble replaces the deep learning ensemble as the group of network heads for the common backbone network.

9. A computer-implemented method, comprising:
accessing, by a device operatively coupled to a processor, a deep learning ensemble configured to perform an inferencing task; and
iteratively distilling, by the device, the deep learning ensemble into a smaller deep learning ensemble configured to perform the inferencing task, wherein a current distillation iteration involves training a new neural network of the smaller deep learning ensemble via a loss function that is based on one or more neural networks of the smaller deep learning ensemble which were trained during one or more previous distillation iterations.

10. The computer-implemented method of claim 9, further comprising:
accessing, by the device, a training dataset, and wherein the current distillation iteration comprises:
initializing, by the device, trainable internal parameters of the new neural network;
selecting, by the device and from the training dataset, one or more training data candidates and one or more ground-truth annotations corresponding to the one or more training data candidates;
executing, by the device, the new neural network on the one or more training data candidates, thereby yielding one or more first inferencing task outputs;
executing, by the device, the deep learning ensemble on the one or more training data candidates, thereby yielding one or more second inferencing task outputs;
updating, by the device and via backpropagation, the trainable internal parameters of the new neural network based on the loss function, wherein the loss function includes a first term that quantifies errors between the one or more first inferencing task outputs and the one or more ground-truth annotations, wherein the loss function includes a second term that quantifies errors between the one or more first inferencing task outputs and the one or more second inferencing task outputs, and wherein the loss function includes a third term that quantifies similarities between the new neural network and the one or more neural networks of the smaller deep learning ensemble which were trained during the one or more previous distillation iterations; and
repeating, by the device, respective above acts until a training termination criterion associated with the new neural network is satisfied.

11. The computer-implemented method of claim 10, wherein the third term of the loss function is based on cosine similarities between:
the trainable internal parameters of the new neural network; and
trainable internal parameters of the one or more neural networks of the smaller deep learning ensemble which were trained during the one or more previous distillation iterations.

12. The computer-implemented method of claim 10, wherein the third term of the loss function is based on reciprocals of distances between:
hidden feature maps produced by the new neural network; and
hidden feature maps produced by the one or more neural networks of the smaller deep learning ensemble which were trained during the one or more previous distillation iterations.

13. The computer-implemented method of claim 10, wherein the current distillation iteration further comprises:
computing, by the device and in response to the training termination criterion being satisfied by the new neural network, a current performance metric of the smaller deep learning ensemble;
comparing, by the device, the current performance metric to a previous performance metric of the smaller deep learning ensemble that was computed during a previous distillation iteration;
commencing, by the device, a next distillation iteration, in response to the current performance metric differing from the previous performance metric by more than a threshold margin; and
determining, by the device, that the smaller deep learning ensemble is complete, in response to the current performance metric differing from the previous performance metric by less than the threshold margin.

14. The computer-implemented method of claim 13, further comprising:
deploying, by the device, the smaller deep learning ensemble, in response to a determination that the smaller deep learning ensemble is complete.

15. The computer-implemented method of claim 9, wherein each neural network of the smaller deep learning ensemble exhibits a smaller footprint than each neural network of the deep learning ensemble.

16. The computer-implemented method of claim 9, wherein the deep learning ensemble serves as a group of network heads for a common backbone network, and wherein the smaller deep learning ensemble replaces the deep learning ensemble as the group of network heads for the common backbone network.

17. A computer program product for facilitating improved distillation of deep ensembles, the computer program product comprising a non-transitory computer-readable memory having program instructions embodied therewith, the program instructions executable by a processor to cause the processor to:
access an ensemble of teacher networks hosted on a medical scanning device and a training dataset;
iteratively train a condensed ensemble of student networks based on the ensemble of teacher networks and based on the training dataset, wherein each new student network of the condensed ensemble is trained via a loss that is based on all previously-trained student networks in the condensed ensemble; and
replace the ensemble of teacher networks on the medical scanning device with the condensed ensemble of student networks.

18. The computer program product of claim 17, wherein the program instructions are further executable to cause the processor to:
cease iteratively training the condensed ensemble when a current performance metric of the condensed ensemble is within a threshold margin of a previous performance metric of the condensed ensemble.

19. The computer program product of claim 17, wherein, for each of the previously-trained student networks, the loss includes a cosine similarity computed between trainable internal parameters of that previously-trained student network and trainable internal parameters of the new student network.

20. The computer program product of claim 17, wherein, for each of the previously-trained student networks, the loss includes a distance computed between hidden activation maps of that previously-trained student network and hidden activation maps of the new student network.
